(19) United States
(12) Patent Application Publication
(10) Pub. No.: US 2017/0248428 A1
(43) Pub. Date: Aug. 31, 2017

(54) INDOOR POSITIONING SYSTEM AND METHOD

(71) Applicant: ELECTRONICS AND TELECOMMUNICATIONS RESEARCH INSTITUTE, Daejeon (KR)

(72) Inventors: Young-Su CHO, Daejeon (KR); Jae-Hyuk CHOI, Daejeon (KR); Joo-Young KIM, Daejeon (KR); Myung-In JI, Daejeon (KR)

(73) Assignee: ELECTRONICS AND TELECOMMUNICATIONS RESEARCH INSTITUTE, Daejeon (KR)

(21) Appl. No.: 15/441,481

(22) Filed: Feb. 24, 2017

(30) Foreign Application Priority Data
Feb. 25, 2016 (KR) 10-2016-0022463
Oct. 21, 2016 (KR) 10-2016-0137935
Feb. 6, 2017 (KR) 10-2017-0016192

(51) Int. Cl. G01C 21/20; H04W 4/04; G01C 21/08; H04W 4/02

(52) U.S. Cl. CPC G01C 21/206; H04W 4/026; H04W 4/043; H04W 4/027; G01C 21/08

(57) ABSTRACT

Disclosed herein are an indoor positioning system and method. The indoor positioning method includes generating measurement information by measuring a geomagnetic field generated from a ferromagnetic substance present in indoor space, and a slope of a user terminal device, generating declination angle information and inclination angle information using the measurement information, generating true north navigation coordinate system-based geomagnetic field vector information using the declination angle information and the inclination angle information, receiving geomagnetic field heatmap information, generated using collection information that is collected at indoor reference locations, and performing indoor positioning based on the true north navigation coordinate system-based geomagnetic field vector information and the geomagnetic field heatmap information.

### CROSS REFERENCE TO RELATED APPLICATIONS

This application claims the benefit of Korean Patent Application Nos. 10-2016-0022463, filed Feb. 25, 2016, 10-2016-0137935, filed Oct. 21, 2016, and 10-2017-0016192, filed Feb. 6, 2017, which are hereby incorporated by reference in their entirety into this application.

### BACKGROUND OF THE INVENTION

1. Technical Field

The present invention relates generally to indoor positioning technology and, more particularly, to wireless communication positioning technology in which geomagnetic field distortion is taken into consideration.

2. Description of the Related Art

Global Positioning System (GPS)-based positioning technology is able to provide the location information of a user terminal equipped with a GPS receiver in a world coordinate system (e.g. latitude, longitude, altitude, etc.) at a location accuracy having an error margin of several m to several tens of m in any outdoor area across the earth by utilizing GPS satellites. In the future, with the extension of additional broadband satellite navigation systems, such as Galileo of Europe and a Global Navigation Satellite System (GLONASS) of Russia, it is predicted that location availability and accuracy will be improved in outdoor areas. However, when the GPS-based positioning technology is used in indoor areas and in congested metropolitan areas, weak signals may be received, or multi-path errors may be increased due to an environment being surrounded by buildings, thus making it impossible to determine the location or deteriorating location accuracy. Further, a problem also arises in that a Time To First Fix (TTFF), caused by a decrease in the number of visible satellites, is increased.

Mobile communication base station-based positioning technology enables such a TIFF to be shorter than that of GPS. However, base station cell-based location determination is disadvantageous in that it generally has location accuracy lower than that of the GPS even if it is influenced by the arrangement of base stations.

Meanwhile, Wi-Fi-, Bluetooth (BT)-, or Bluetooth Low Energy (BLE)-based positioning technology can provide precise location information having an error margin of about several m using the intensities of signals received from Wi-Fi Access Points (APs), BT or BLE beacons in an area in which GPS signals are not received, the indoor area of a large building having a high GPS location error, or a congested metropolitan area. Recently, an area in which service is available has been extended to a great city area using Wardriving (or AP mapping) technology based on Skyhook Wireless in the United States. However, Wardriving (or AP mapping) technology using vehicles is problematic in that high costs are incurred to initially construct the location database (DB) of Wi-Fi APs, BT or BLE beacons. Further, since collection is mainly performed in outdoor areas, collection locations are implemented using GPS location information. Due thereto, there is a problem in that in an indoor area, where it is difficult to receive GPS signals, it is impossible to obtain collection locations.

For technology for obtaining collection locations in indoor areas, a scheme for selecting collection locations or areas (e.g. a room, a passage, the surrounding area of interest, etc.), indicated on an indoor map, and a scheme for allowing a user to enter text have been used. Further, methods for allowing a mobile terminal to dynamically provide collection locations to an indoor environment using an indoor map and sensor information in the terminal also have been presented.

Meanwhile, as one method for providing positioning in an indoor environment in which wireless communication positioning infrastructure elements (e.g. a Wi-Fi AP, a beacon, a femto-cell, etc.) are not installed, the Earth's magnetic field (i.e. geomagnetic field)-based positioning method has been proposed. When a geomagnetic sensor is present in a terminal, there is an advantage in that a geomagnetic field may be measured in any indoor environment, whereas a distortion phenomenon occurs sensitively to the structure, interior design, etc. of an indoor building compared to the measurement information (e.g. Received Signal Strength Indication: RSSI) or the like of conventional wireless communication positioning infrastructure. Further, geomagnetic field values measured based on a terminal coordinate system vary depending on the orientation of a user terminal. Accordingly, when positioning is performed using geomagnetic field values of a randomly moving user terminal, it is necessary to calculate navigation coordinate system-based geomagnetic field values, which are not related to the orientation of the terminal upon generating a geomagnetic location DB.

Meanwhile, Korean Patent Application Publication No. 10-2015-0032698, entitled “Systems and Methods for Network Centric WLAN location of a Mobile Device”, discloses systems, methods, apparatuses, and computer-readable media for using Wireless Local Area Network (WLAN) Access Points (APs), Secure User Plane Location (SUPL), a Long Term Evolution (LTE) positioning protocol (LPP), and/or LPP Extensions (LPPe) to determine the location of a mobile device such as a cellphone, a smartphone, or a laptop.

However, the technology disclosed in Korean Patent Application Publication No. 10-2015-0032698 is limited in that a geomagnetic field from an indoor ferromagnetic substance is not taken into consideration, thus making it impossible to realize accurate indoor positioning.

### SUMMARY OF THE INVENTION

Accordingly, the present invention has been made keeping in mind the above problems occurring in the prior art, and an object of the present invention is to correct indoor positioning information by compensating for geomagnetic field distortion caused by a ferromagnetic substance that influences a geomagnetic field in an indoor environment.

Another object of the present invention is to improve the accuracy of indoor positioning by providing stable measurement information related to the movement of a terminal.

A further object of the present invention is to store pieces of geomagnetic vector information for respective reference locations in indoor space into a database so as to compensate for geomagnetic field distortion.

In accordance with an aspect of the present invention to accomplish the above objects, there is provided In accordance with an aspect of the present invention to accomplish the above objects, there is provided an indoor positioning method performed by an indoor positioning system, including generating measurement information by measuring a geomagnetic field generated from a ferromagnetic substance present in indoor space, and a slope of a user terminal device; calculating magnetic north navigation coordinate system-based geomagnetic vector information, declination angle information, and inclination angle information using the measurement information; converting the magnetic north navigation coordinate system-based geomagnetic vector information into true north navigation coordinate system-based geomagnetic field vector information using the declination angle information and the inclination angle information; and performing indoor positioning based on the true north navigation coordinate system-based geomagnetic field vector information and the geomagnetic field heatmap information.

Generating the measurement information may be configured to generate the measurement information by measuring at least one of an azimuth, an acceleration vector, a gravity vector, a rotation vector, and a geomagnetic field vector of the user terminal device which are based on a terminal coordinate system, using sensors included in the user terminal device.

Generating the measurement information may be configured to measure roll, pitch, and yaw angles of the user terminal device.

Generating the measurement information may be configured to correct the measurement information by additionally considering atmospheric pressure information and temperature information, which are measured by the user terminal device.

Generating the declination angle information and the inclination angle information may be configured to calculate an angle, obtained by subtracting the yaw angle from the azimuth, as the declination angle.

Generating the declination angle information and the inclination angle may be configured to calculate the inclination angle using the acceleration vector or the gravity vector and the geomagnetic vector.

The true north navigation coordinate system-based geomagnetic field vector information may include three degrees of freedom, wherein the three degrees of freedom correspond to a true north geomagnetic field vector, an eastward geomagnetic field vector, and a vertical geomagnetic field vector, respectively.

Performing the indoor positioning may be configured to estimate a location of the user terminal device using geomagnetic field heatmap information, received from an indoor positioning server device, and the true north navigation coordinate system-based geomagnetic field vector information.

Performing the indoor positioning may be configured to compare the true north navigation coordinate system-based geomagnetic field vector information with pieces of geomagnetic field vector information for respective indoor reference locations, included in the geomagnetic field heatmap information, and estimate a reference location corresponding to geomagnetic field vector information that is most similar to the true north navigation coordinate system-based geomagnetic field vector information to be the location of the user terminal device.

Performing the indoor positioning may be configured to individually compare the compare the true north navigation coordinate system-based geomagnetic field vector information with the true north geomagnetic field vector, the eastward geomagnetic field vector, and the vertical geomagnetic field vector which correspond to the three degrees of freedom of the geomagnetic field heatmap information, and estimate a reference location of the heatmap information at which the vectors corresponding to the three degrees of freedom are most similar to the true north navigation coordinate system-based geomagnetic field vector information to be the location of the user terminal device.

In accordance with another aspect of the present invention to accomplish the above objects, there is provided an indoor positioning system, including a user terminal device for generating magnetic north navigation coordinate system-based geomagnetic field vector information, declination angle information, and inclination angle information using measurement information obtained by measuring a geomagnetic field present in indoor space and a slope of the user terminal device, and for converting the magnetic north navigation coordinate system-based geomagnetic field vector information into true north navigation coordinate system-based geomagnetic field vector information using the declination angle information and the inclination angle information, thus performing indoor positioning, and an indoor positioning server device for generating true north navigation coordinate system-based geomagnetic field vector information at indoor reference locations using collection information that is collected at the indoor reference locations so as to perform indoor positioning, and providing the true north navigation coordinate system-based geomagnetic field vector information to the user terminal device.

The true north navigation coordinate system-based geomagnetic field vector information may include three degrees of freedom, wherein the three degrees of freedom correspond to a true north geomagnetic field vector, an eastward geomagnetic field vector, and a vertical geomagnetic field vector, respectively.

The indoor positioning server device may generate the geomagnetic field heatmap information related to indoor space using true north navigation coordinate system-based geomagnetic field vector information, which is calculated from the collection information collected at the reference locations.

Here, the user terminal device may estimate the location of the user terminal device using the geomagnetic field heatmap information received from the indoor positioning server device and the true north navigation coordinate system-based geomagnetic field vector information.

The indoor positioning server device may be configured such that, when a difference between pieces of geomagnetic field vector information at consecutive reference locations of the geomagnetic field heatmap information is equal to or greater than a first preset value, the difference between the pieces of geomagnetic field vector information is compensated for in order to make the difference be less than the first preset value.

The indoor positioning server device may be configured such that, when a difference between vector values at first and second consecutive reference locations with respect to at least one of a true north geomagnetic field vector, an eastward geomagnetic field vector, and a vertical geomagnetic field vector, which correspond to three degrees of freedom included in geomagnetic field heatmap information, is equal to or greater than the first preset value, the at least one vector is compensated for in order to make the difference be less than the first preset value.

The user terminal device may estimate a location of the user terminal device using the geomagnetic field heatmap information, received from the indoor positioning server device, and the true north navigation coordinate system-based geomagnetic field vector information.

The user terminal device may compare the true north navigation coordinate system-based geomagnetic field vector information with pieces of geomagnetic field vector information for respective indoor reference locations, included in the geomagnetic field heatmap information, and may estimate a reference location corresponding to geomagnetic field vector information that is most similar to the true north navigation coordinate system-based geomagnetic field vector information to be the location of the user terminal device.

The user terminal device may individually compare the true north navigation coordinate system-based geomagnetic field vector information with the true north geomagnetic field vector, the eastward geomagnetic field vector, and the vertical geomagnetic field vector which correspond to the three degrees of freedom of the geomagnetic field heatmap information, and may estimate a reference location of the geomagnetic heatmap information at which the vectors corresponding to the three degrees of freedom are most similar to the true north navigation coordinate system-based geomagnetic field vector information to be the location of the user terminal device.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating an indoor positioning system according to an embodiment of the present invention;

FIG. 2 is a block diagram illustrating in detail an embodiment of the collection terminal device shown in FIG. 1;

FIG. 3 is a block diagram illustrating in detail an embodiment of the indoor positioning server device shown in FIG. 1;

FIG. 4 is a diagram illustrating the definition of axes of a terminal device according to an embodiment of the present invention;

FIG. 5 is a block diagram illustrating in detail an embodiment of the user terminal device shown in FIG. 1;

FIG. 6 is a diagram illustrating a true north navigation coordinate system according to an embodiment of the present invention;

FIGS. 7 and 8 are diagrams showing true north navigation coordinate system-based geomagnetic field vectors according to an embodiment of the present invention;

FIG. 9 is a diagram illustrating an indoor area in which grids are defined so as to generate geomagnetic field information according to an embodiment of the present invention;

FIG. 10 is a diagram illustrating an indoor map on which indoor positioning is performed according to an embodiment of the present invention;

FIG. 11 is a graph illustrating declination angle information according to an embodiment of the present invention;

FIG. 12 is a graph illustrating inclination angle information according to an embodiment of the present invention;

FIG. 13 is a graph illustrating geomagnetic field vector information before correction according to an embodiment of the present invention;

FIG. 14 is a graph illustrating geomagnetic field vector information after correction according to an embodiment of the present invention;

FIG. 15 is a graph illustrating upward geomagnetic field vector information before and after correction according to an embodiment of the present invention;

FIG. 16 is a flowchart illustrating a collection information generation method performed by a collection terminal device according to an embodiment of the present invention;

FIG. 17 is a flowchart illustrating a heatmap information generation method performed by an indoor positioning server device according to an embodiment of the present invention;

FIG. 18 is a flowchart illustrating an indoor positioning method performed by a user terminal device according to an embodiment of the present invention; and

FIG. 19 is a block diagram illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

In the present specification, an expression indicating that a certain part “includes” a certain component means that one or more other components may be further included in the certain part without excluding the possibility that one or more other components will be present or added, unless a description to the contrary is specifically pointed out in context.

Hereinafter, preferred embodiments of the present invention will be described in detail with reference to the attached drawings.

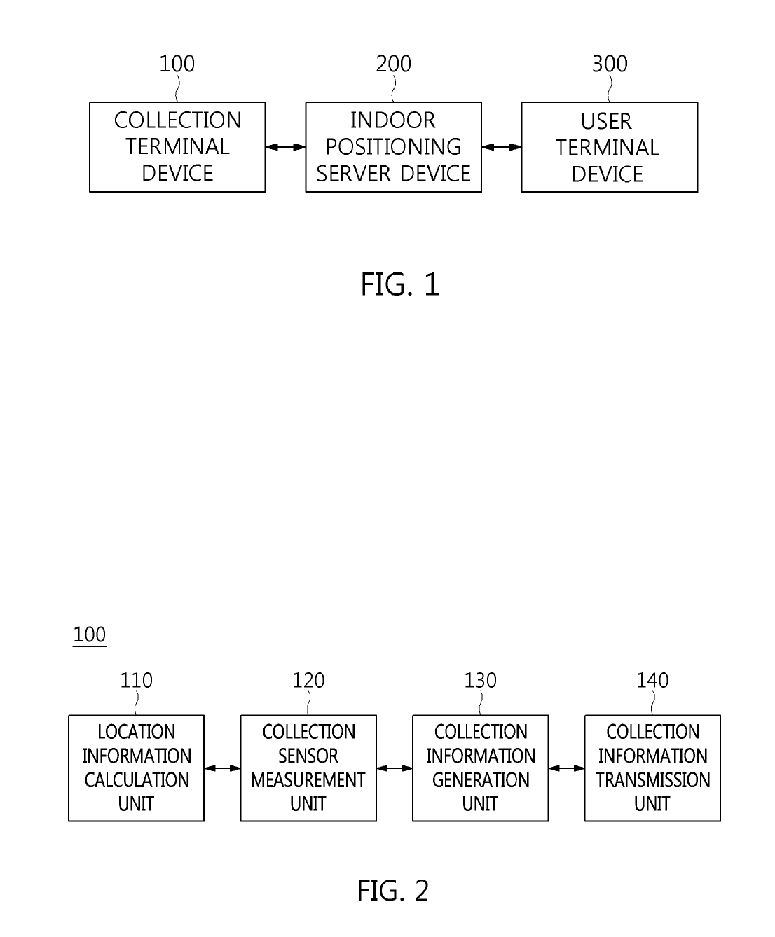

FIG. 1 is a block diagram illustrating an indoor positioning system according to an embodiment of the present invention.

Referring to FIG. 1, the indoor positioning system according to an embodiment of the present invention includes a collection terminal device 100, an indoor positioning server device 200, and a user terminal device 300.

The collection terminal device 100 may be a device or a terminal having the function of calculating location information in a dynamic environment and collecting measurement information using sensors included therein.

Here, the collection terminal device 100 may be a survey device.

Here, the collection terminal device 100 may generate collection information using the location information and the measurement information.

Here, the collection terminal device 100 may transmit the generated collection information to the indoor positioning server device 200.

Here, the collection terminal device 100 may include multiple collection terminal devices that may be installed at indoor locations, and respective collection terminal devices 100 may generate collection information and transmit the collection information to the indoor positioning server device 200.

The indoor positioning server device 200 may generate geomagnetic field heatmap information by receiving the collection information from the collection terminal devices 100.

Here, the indoor positioning server device 200 may generate geomagnetic field heatmap information based on pieces of geomagnetic field information for respective collection locations using the collection information received from the multiple collection terminal devices 100.

Here, the indoor positioning server device 200 may transmit the geomagnetic field heatmap information to the user terminal device 300.

The user terminal device 300 may generate true north navigation coordinate system-based geomagnetic field vector information, may receive the geomagnetic field heatmap information from the indoor positioning server device 200, and may perform indoor positioning in which geomagnetic field distortion is compensated for.

Here, the user terminal device 300 may generate positioning measurement information by measuring an indoor geomagnetic field and a slope.

Here, the user terminal device 300 may generate geomagnetic field vector information using the positioning measurement information.

Here, the user terminal device 300 may receive the geomagnetic field heatmap information from the indoor positioning server device 200.

Here, the user terminal device 300 may perform indoor positioning using the geomagnetic field vector information and the geomagnetic field heatmap information.

FIG. 2 is a block diagram illustrating in detail an embodiment of the collection terminal device shown in FIG. 1.

Referring to FIG. 2, the collection terminal device 100 may include a location information calculation unit 110, a collection sensor measurement unit 120, a collection information generation unit 130, and a collection information transmission unit 140.

The location information calculation unit 110 may generate location information by combining indoor node/link information at collection locations using sensors included in the collection terminal device 100.

Here, the sensors may include a geomagnetic sensor, an accelerometer, a gravimeter, a gyroscope, an altimeter, a camera, etc.

The collection sensor measurement unit 120 may generate measurement information by measuring the azimuths, acceleration vectors, gravity vectors, rotation vectors, geomagnetic field vectors, etc. at the collection locations using the sensors.

Here, the collection locations of the collection terminal device 100 may correspond either to pieces of location information (e.g. reference locations, absolute locations, relative locations, address locations, etc.) combined with the geomagnetic field heatmap information or to location indices (e.g. indices capable of referring to location information, rather than direct location information, in order to protect location information). The location information may be each collection location itself, at which information is collected, or may correspond to virtual locations processed at regular intervals or reference locations.

Here, the collection sensor measurement unit 120 may measure roll, pitch, and yaw angles of the collection terminal device 100 using the sensors.

Here, the collection sensor measurement unit 120 may correct the measurement information by additionally considering measured atmospheric pressure information and temperature information.

The collection information generation unit 130 may generate collection information using the location information and the measurement information, and may store the collection information while temporally synchronizing it.

The collection information transmission unit 140 may transmit the collection information to the indoor positioning server device 200.

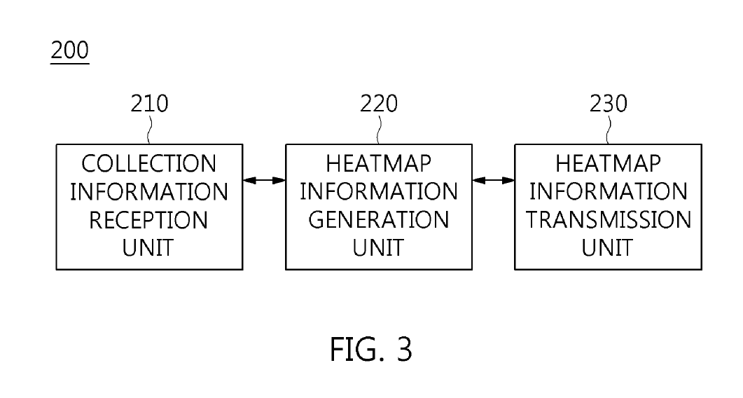

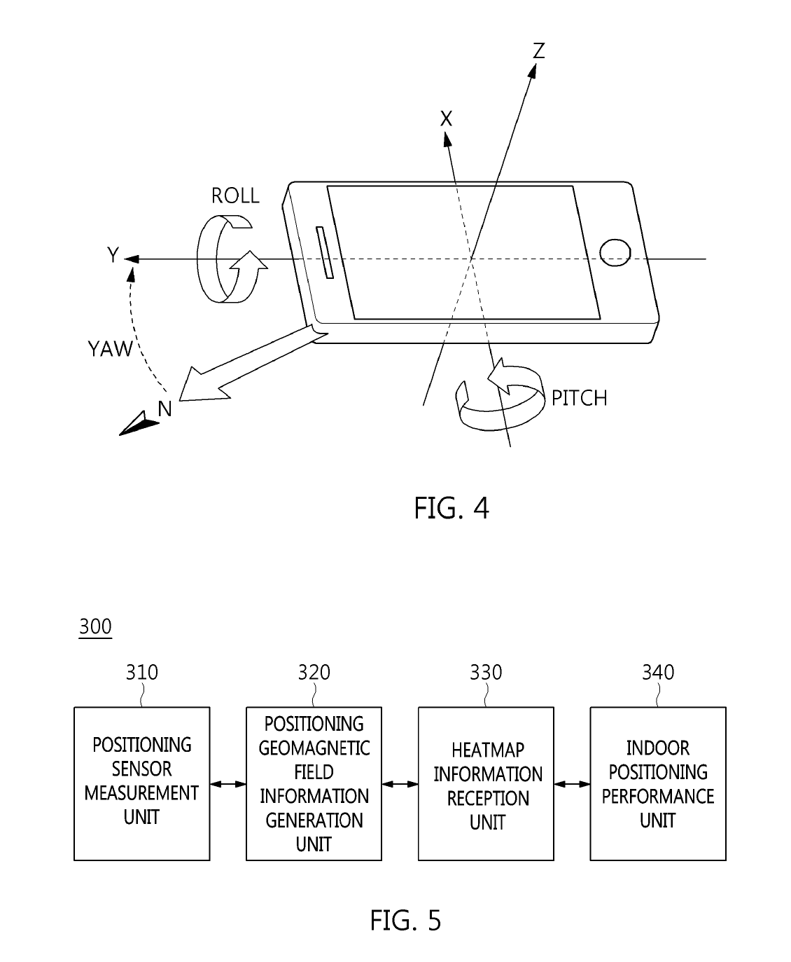

FIG. 3 is a block diagram illustrating in detail an embodiment of the indoor positioning server device shown in FIG. 1. FIG. 4 is a diagram illustrating the definition of axes of a terminal device according to an embodiment of the present invention.

Referring to FIG. 3, the indoor positioning server device 200 may include a collection information reception unit 210, a heatmap information generation unit 220, and a heatmap information transmission unit 230.

The collection information reception unit 210 may receive collection information from the collection terminal device 100.

The heatmap information generation unit 220 may generate geomagnetic field heatmap information using the collection information.

Here, the heatmap information generation unit 220 may calculate magnetic north or true north navigation coordinate system-based geomagnetic field vector information, declination angle information, and inclination angle information using the collection information.

Here, the heatmap information generation unit 220 may calculate magnetic north navigation coordinate system-based geomagnetic field vector information using the following Equation (1):

Hₑₙᵤ_{_}_{MN}=R⁻¹(ψ)R⁻¹(θ)R⁻¹(φ)M_{xyz} (1)

where Mₑₙᵤ_{_}_{MN} denotes a magnetic north navigation coordinate system-based geomagnetic field vector and M_{xyz} denotes a terminal coordinate system-based geomagnetic field vector.

Here, the heatmap information generation unit 220 may convert the terminal coordinate system-based geomagnetic field vector into the magnetic north navigation coordinate system-based geomagnetic field vector by multiplying the rotation vector matrices of the terminal by the terminal coordinate system-based geomagnetic field vector, as given by Equation (1).

Here, the rotation matrices in Equation (1) may be represented in detail by the following Equations (2) to (4), based on the definition of axes of the terminal device shown in FIG. 4.

$$\begin{matrix}{R}_{y} ( φ ) = [ \begin{matrix}1 & 0 & 0 \\ 0 & cos φ & sin φ \\ 0 & - sin φ & cos φ\end{matrix} ] & ( 2 ) \\ {R}_{x} ( θ ) = [ \begin{matrix}cos θ & 0 & - sin θ \\ 0 & 1 & 0 \\ sin θ & 0 & cos φ\end{matrix} ] & ( 3 ) \\ {R}_{z} ( ψ ) = [ \begin{matrix}cos ψ & sin ψ & 0 \\ - sin ψ & cos ψ & 0 \\ 0 & 0 & 1\end{matrix} ] & ( 4 )\end{matrix}$$

Here, as shown in FIG. 4, Equation (2) indicates a rotation matrix when the terminal device is rotated by φ (roll) along the y axis of a collection terminal coordinate system.

Equation (3) indicates a rotation matrix when the terminal device is rotated by θ (pitch) along the x axis of the collection terminal coordinate system.

Equation (4) indicates a rotation matrix when the terminal device is rotated by ψ (yaw) along the z axis of the collection terminal coordinate system.

Referring to FIG. 4, it can be seen that the terminal device (the collection terminal device 100 or the user terminal device 300) according to an embodiment of the present invention defines the axes of sensors.

Here, a positive X axis may extend to the right of the terminal device (i.e. user equipment: UE).

A positive Y axis may extend upwards from the top of the terminal device.

A positive Z axis may extend to the front of the terminal device. This may be irrespective of the orientation of the terminal device (UE).

A positive yaw angle may be an angle from magnetic north to the positive Y axis, and may range from 0 to 360°.

A positive roll angle may be defined when the positive Z axis starts to incline towards the positive X axis in the state in which the terminal device is laid flat on a table.

A positive pitch angle may be defined when the positive Z axis starts to incline towards the positive Y axis in the state in which the terminal device is laid flat on a table.

Here, the heatmap information generation unit 220 may convert terminal coordinate system-based geomagnetic field vectors for respective collection locations (reference locations) of an indoor map into magnetic north navigation coordinate system-based geomagnetic field vectors.

Further, the heatmap information generation unit 220 may generate declination angle information using the collection information.

The declination angle may correspond to the angle between true north and magnetic north on a horizontal plane.

Here, the heatmap information generation unit 220 may calculate the declination angle using the following Equation (5):

declination=Az−ψ (5)

In Equation (5), Az denotes the azimuth of the terminal device, and Ψ denotes the yaw angle of the terminal device.

Here, the azimuth may correspond to an angle obtained by adding a magnetic bearing to a magnetic declination.

That is, the heatmap information generation unit 220 may calculate the declination angle by subtracting the yaw angle from the azimuth of the collection terminal device 100, which is included in the collection information.

Further, the heatmap information generation unit 220 may generate inclination angle information using the collection information.

The inclination angle may correspond to the angle at which a geomagnetic field line (magnetic needle) is inclined with respect to a horizontal direction.

Here, the heatmap information generation unit 220 may calculate the inclination angle using the following Equation (6):

$$inclination = \frac{π}{2} - arccos ( \frac{{M}_{xyz} \cdot {A}_{xyz}}{\vert {M}_{xyz} ‖ {A}_{xyz} \vert} ) \qquad ( 6 )$$

In Equation (6), M_{xyz} denotes a terminal coordinate system-based geomagnetic field vector, and A_{xyz} denotes a terminal coordinate system-based acceleration vector or gravity vector, “” denotes an inner product operator of two vectors, and “∥” denotes a norm operator of two vectors.

Here, the heatmap information generation unit 220 may convert the magnetic north navigation coordinate system-based geomagnetic field vector information into true north navigation coordinate system-based geomagnetic field vector information using the declination angle information and the inclination angle information.

In this case, the heatmap information generation unit 220 may convert a magnetic north navigation coordinate system-based geomagnetic field vector into a true north navigation coordinate system-based geomagnetic field vector using the following Equation (7):

Mₑₙᵤ_{_}_{TN}=R_{z}⁻(declination)Mₑₙᵤ_{_}_{MN} (7)

Here, the heatmap information generation unit 220 may convert the magnetic north navigation coordinate system-based geomagnetic field vector into the true north navigation coordinate system-based geomagnetic field vector by multiplying a rotation inverse matrix, which is rotated at the declination angle along the z axis of the terminal coordinate system, by the magnetic north navigation coordinate system-based geomagnetic field vector.

Further, the heatmap information generation unit 220 may generate a true north navigation coordinate system-based geomagnetic field vector using the inclination angle information and the declination angle information from a terminal coordinate system-based geomagnetic field vector, as given by the following Equation (8), without calculating the magnetic north navigation coordinate system-based geomagnetic field vector.

M_{N}=|M_{xyz}|cos(I)cos(D)

M_{E}=|M_{xyz}|cos(I)cos(D) (8)

M_{D}=−|M_{xyz}|sin(I)

In this case, the heatmap information generation unit 220 may calculate a true north geomagnetic field vector M_{N}, an eastward geomagnetic field vector M_{E}, and a downward geomagnetic field vector M_{D}, using the magnitude of the terminal coordinate system-based geomagnetic field vector M_{xyz}, the declination angle D, and the inclination angle I, as represented by Equation (8).

Here, the downward geomagnetic field vector may be used as an upward geomagnetic field vector M_{U} by changing the negative (−) sign of the downward geomagnetic field vector to a positive (+) sign.

That is, any one of the upward and downward geomagnetic field vectors may be used as a vertical geomagnetic field vector.

Here, the heatmap information generation unit 220 may generate true north navigation coordinate system-based geomagnetic field vector information, which includes three elements or three degrees of freedom.

Here, the true north navigation coordinate system-based geomagnetic field vector information may include three degrees of freedom, which correspond to a true north geomagnetic field vector, an eastward geomagnetic field vector, and a vertical (upward or downward) geomagnetic field vector, respectively.

Further, the heatmap information generation unit 220 may generate geomagnetic field heatmap information by generating true north navigation coordinate system-based geomagnetic field vector information for respective collection locations using pieces of collection information received from multiple collection terminal devices 100.

Furthermore, the heatmap information generation unit 220 may generate, for each of indoor reference locations, geomagnetic field heatmap information using the true north navigation coordinate system-based geomagnetic field vector information, which includes three elements or three degrees of freedom.

Here, the geomagnetic field heatmap information may include, for each of the indoor reference locations, a true north geomagnetic field vector value, an eastward geomagnetic field vector value, and a vertical geomagnetic field vector value.

Here, the reference locations may correspond to the locations at which the collection terminal devices 100 are installed.

Here, the collection locations may correspond either to pieces of location information (e.g. reference locations, absolute locations, relative locations, address locations, etc.) combined with the geomagnetic field heatmap information, or location indices (e.g. indices capable of referring to location information, rather than direct location information, in order to protect location information). The location information may indicate collection locations themselves at which information is collected, may indicate virtual locations processed at regular intervals, or may indicate reference locations.

Here, the true north navigation coordinate system-based geomagnetic field vector may represent geomagnetic field information unique to each reference location regardless of the orientation or slope of the terminal.

Therefore, the heatmap information generation unit 220 may generate accurate geomagnetic field heatmap information using the true north navigation coordinate system-based geomagnetic field vector, regardless of the slope, rotation or motion state of each collection terminal device 100.

Furthermore, the heatmap information generation unit 220 may compensate for geomagnetic field heatmap information.

Here, in the geomagnetic field heatmap information, discontinuity may occur over time due to the malfunctioning of the geomagnetic sensor of the collection terminal device 100 that collects collection information, errors in application programs, etc.

In this case, since the geomagnetic field does not rapidly change in space, the geomagnetic field may have continuous geomagnetic field vector values at consecutive reference locations for each axis.

When, for each axis, the difference between geomagnetic field vector values at consecutive reference locations is equal to or greater than a reference value, the heatmap information generation unit 220 may compensate for the difference.

Here, when the difference between vector values at first and second consecutive reference locations with respect to at least one of a true north geomagnetic field vector, an eastward geomagnetic field vector, and a vertical (downward or upward) geomagnetic field vector, which correspond to the three degrees of freedom included in the geomagnetic field heatmap information, is equal to or greater than a first preset value, the heatmap information generation unit 220 may compensate for at least one vector corresponding to the second reference location so that the difference becomes less than the first preset value.

The heatmap information transmission unit 230 may transmit the generated geomagnetic field heatmap information to the user terminal device 300.

Here, the heatmap information transmission unit 230 may provide information about locations at which collection terminal devices 100 are installed in indoor space, information about paths through which the user can move, branch point (node) information, azimuth information, etc.

Here, the heatmap information transmission unit 230 may transmit and receive positioning capability information and positioning correction information to and from the user terminal device 300.

FIG. 5 is a block diagram illustrating in detail an embodiment of the user terminal device shown in FIG. 1.

The user terminal device 300 may be a wireless communication mobile device capable of performing indoor positioning.

Here, the user terminal device 300 may support an LTE Positioning Protocol extension (LPPe) 1.0 or 2.0.

Referring to FIG. 5, the user terminal device 300 may include a positioning sensor measurement unit 310, a positioning geomagnetic field information generation unit 320, a heatmap information reception unit 330, and an indoor positioning performance unit 340.

The positioning sensor measurement unit 310 may generate, for the user terminal device 300, measurement information using a method similar to that of the collection sensor measurement unit 120 of the collection terminal device 100.

The positioning sensor measurement unit 310 may generate measurement information related to a geomagnetic field at the current location and the slope of the user terminal device 300 itself by using sensors included in the user terminal device 300.

Here, the sensors may include a geomagnetic sensor, an accelerometer, a gravimeter, a gyroscope, an altimeter, a camera, etc.

The positioning sensor measurement unit 310 may generate measurement information by measuring an azimuth, an acceleration vector, a gravity vector, a rotation vector, a geomagnetic field vector, etc. for the slope of the user terminal device 300 using the sensors.

Here, the positioning sensor measurement unit 310 may measure roll, pitch, and yaw angles of the user terminal device 300 using the sensors.

In this case, the positioning sensor measurement unit 310 may correct the measurement information by additionally considering measured atmospheric pressure information and temperature information.

The positioning geomagnetic field information generation unit 320 may generate true north navigation coordinate system-based geomagnetic field information using a method similar to that of the heatmap information generation unit 220 of the indoor positioning server device 200.

Here, the positioning geomagnetic field information generation unit 320 may calculate magnetic north or true north navigation coordinate system-based geomagnetic field vector information, declination angle information, and inclination angle information using the measurement information.

Here, the positioning geomagnetic field information generation unit 320 may calculate the magnetic north navigation coordinate system-based geomagnetic field vector information using Equation (1).

Here, the positioning geomagnetic field information generation unit 320 may convert terminal coordinate system-based geomagnetic field vectors into magnetic north navigation coordinate system-based geomagnetic field vectors by multiplying the rotation vector matrices of the terminal by the terminal coordinate system-based geomagnetic field vectors, as represented by Equation (1).

Here, the positioning geomagnetic field information generation unit 320 may convert the terminal coordinate system-based geomagnetic field vectors into the magnetic north navigation coordinate system-based geomagnetic field vectors.

Also, the positioning geomagnetic field information generation unit 320 may generate the declination angle information using the measurement information.

The declination angle may correspond to an angle between true north and magnetic north on a horizontal plane.

Here, the positioning geomagnetic field information generation unit 320 may calculate the declination angle using Equation (5).

That is, the positioning geomagnetic field information generation unit 320 may calculate the declination angle by subtracting the yaw angle from the azimuth of the user terminal device 300, which is included in the measurement information.

Further, the positioning geomagnetic field information generation unit 320 may generate the inclination angle information using the measurement information.

The inclination angle may correspond to the angle at which a geomagnetic field line (magnetic needle) is inclined with respect to a horizontal direction.

Here, the positioning geomagnetic field information generation unit 320 may calculate the inclination angle using Equation (6).

Here, the positioning geomagnetic field information generation unit 320 220 may convert the magnetic north navigation coordinate system-based geomagnetic field vector information into true north navigation coordinate system-based geomagnetic field vector information, using the declination angle information and the inclination angle information.

Here, the positioning geomagnetic field information generation unit 320 may convert a magnetic north navigation coordinate system-based geomagnetic field vector into a true north navigation coordinate system-based geomagnetic field vector using Equation (7).

Here, the positioning geomagnetic field information generation unit 320 may convert the magnetic north navigation coordinate system-based geomagnetic field vector into the true north navigation coordinate system-based geomagnetic field vector by multiplying a rotation inverse matrix, which is rotated at the declination angle along the z axis of the terminal coordinate system, by the magnetic north navigation coordinate system-based geomagnetic field vector.

Further, the positioning geomagnetic field information generation unit 320 may generate a true north navigation coordinate system-based geomagnetic field vector using the inclination angle information and the declination angle information from a terminal coordinate system-based geomagnetic field vector, as given by Equation (8), without calculating the magnetic north navigation coordinate system-based geomagnetic field vector.

Here, the positioning geomagnetic field information generation unit 320 may calculate a true north geomagnetic field vector M_{N}, an eastward geomagnetic field vector M_{E}, and a downward geomagnetic field vector M_{D}, using the magnitude of the terminal coordinate system-based geomagnetic field vector M_{xyz}, the declination angle D, and the inclination angle I, as represented by Equation (8).

Here, the downward geomagnetic field vector may be used as an upward geomagnetic field vector M_{U} by changing the negative (−) sign of the downward geomagnetic field vector to a positive (+) sign.

That is, any one of the upward and downward geomagnetic field vectors may be used as a vertical geomagnetic field vector.

Here, the positioning geomagnetic field information generation unit 320 may generate true north navigation coordinate system-based geomagnetic field vector information, which includes three elements or three degrees of freedom.

Here, the true north navigation coordinate system-based geomagnetic field vector information may include three degrees of freedom, which correspond to a true north geomagnetic field vector, an eastward geomagnetic field vector, and a vertical (upward or downward) geomagnetic field vector, respectively.

Further, the positioning geomagnetic field information generation unit 320 may generate true north navigation coordinate system-based geomagnetic field vector information using the measurement information which is measured in the indoor movement path of the user terminal device 300.

Here, the positioning geomagnetic field information generation unit 320 may generate true north navigation coordinate system-based geomagnetic field vector information, which includes three elements or three degrees of freedom in the indoor movement path.

The true north navigation coordinate system-based geomagnetic field vector information may include true north geomagnetic field vector values, eastward geomagnetic field vector values, and vertical geomagnetic field vector values in the indoor movement path.

The movement path may be a path along which the user terminal device 300 is moved in indoor space.

The true north navigation coordinate system-based geomagnetic vector may represent geomagnetic field information unique to each reference location regardless of the orientation or slope of the terminal.

Therefore, the positioning geomagnetic field information generation unit 320 may generate accurate geomagnetic field vector information using the true north navigation coordinate system-based geomagnetic field vector, regardless of the slope, rotation or motion state of the user terminal device 300.

Furthermore, the positioning geomagnetic field information generation unit 320 may compensate for the true north navigation coordinate system-based geomagnetic field vector information.

Here, in the true north navigation coordinate system-based geomagnetic field vector information, discontinuity may occur over time due to the malfunctioning of the geomagnetic sensor of the user terminal device 300 that generates the measurement information, errors in application programs, etc.

Here, since a geomagnetic field does not rapidly change in space, the geomagnetic field may have continuous geomagnetic field vector values at consecutive reference locations for each axis.

Therefore, when, for each axis, the difference between geomagnetic field vector values at consecutive reference locations in the movement path is equal to or greater than a reference value, the positioning geomagnetic field information generation unit 320 may compensate for the difference.

Here, when the difference between vector values at first and second consecutive reference locations in the movement path with respect to at least one of a true north geomagnetic field vector, an eastward geomagnetic field vector, and a vertical (downward or upward) geomagnetic field vector, which correspond to the three degrees of freedom included in the true-north navigation coordinate system-based geomagnetic field vector information, is equal to or greater than a first preset value, the positioning geomagnetic field information generation unit 320 may compensate for at least one vector corresponding to the second reference location so that the difference becomes less than the first preset value.

The heatmap information reception unit 330 may receive the geomagnetic field heatmap information from the indoor positioning server device 200.

Here, the heatmap information reception unit 330 may receive information about locations at which collection terminal devices 100 are installed in indoor space, information about paths through which the user can move, branch point (node) information, azimuth information, etc.

Here, the heatmap information reception unit 330 may transmit and receive positioning capability information and positioning correction information to and from the indoor positioning server device 200.

The indoor positioning performance unit 340 may perform indoor positioning based on the true north navigation coordinate system-based geomagnetic field vector information and the geomagnetic field heatmap information.

Here, the indoor positioning performance unit 340 may estimate the location of the user terminal device 300 using the geomagnetic field heatmap information, received from the indoor positioning server device 200, and the true north navigation coordinate system-based geomagnetic field vector information.

Here, the indoor positioning performance unit 340 may compare the true-north navigation coordinate system-based geomagnetic field vector information with pieces of geomagnetic field vector information for respective indoor reference locations included in the geomagnetic field heatmap information, and may then estimate a reference location corresponding to the geomagnetic field vector information that is most similar to the true-north navigation coordinate system-based geomagnetic field vector information to be the location of the user terminal device 300.

In this regard, the indoor positioning performance unit 340 may individually compare the true north navigation coordinate system-based geomagnetic field vector information with a true north geomagnetic field vector, an eastward geomagnetic field vector, and a vertical geomagnetic field vector, which correspond to the three degrees of freedom of the heatmap information, and may estimate the reference location of heatmap information at which the vectors corresponding to the three degrees of freedom are most similar to the true north navigation coordinate system-based geomagnetic field vector information to be the location of the user terminal device 300.

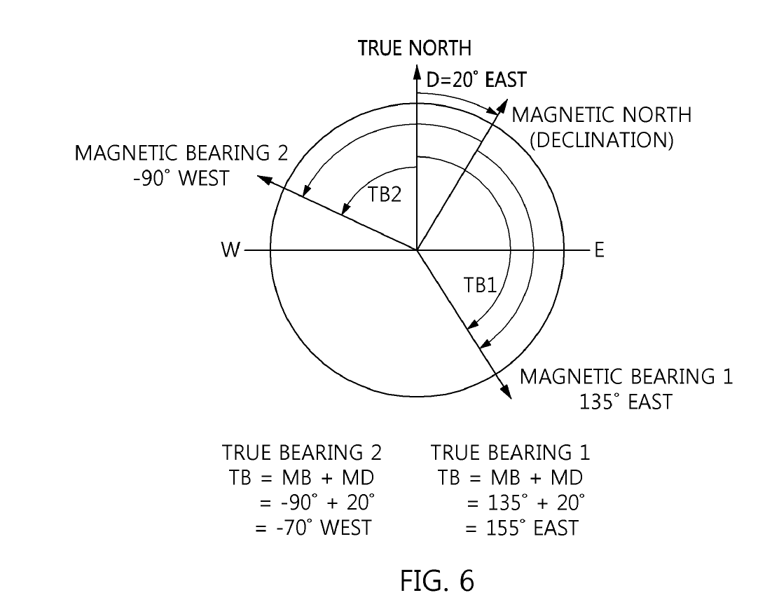

FIG. 6 is a diagram illustrating a true north navigation coordinate system according to an embodiment of the present invention.

Referring to FIG. 6, an azimuth (or a true nearing: TB) may be calculated as the sum of a magnetic bearing (MB) and a magnetic declination (MD).

It can be seen that a declination angle D, which is an angle between true north and magnetic north, indicates 20°.

Here, the declination angle D may correspond to the magnetic bearing (MB).

In this case, it can be known that, for east azimuth (TB1), a first magnetic bearing (MB) indicates plus (+) 135°, and thus TB1 indicates plus (+) 155° by adding the magnetic declination MD to the first MB, and for west azimuth (TB2), a second magnetic bearing (MB) indicates minus (−) 90°, and thus TB2 indicates minus (−) 70° by adding the magnetic declination (MD) to the second MB.

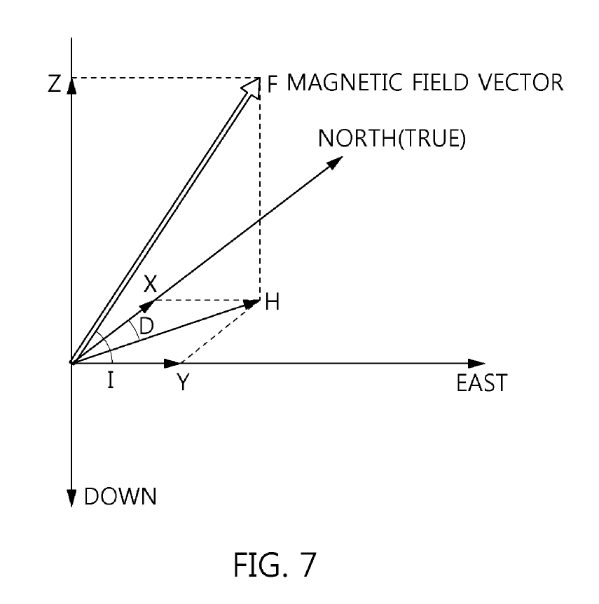

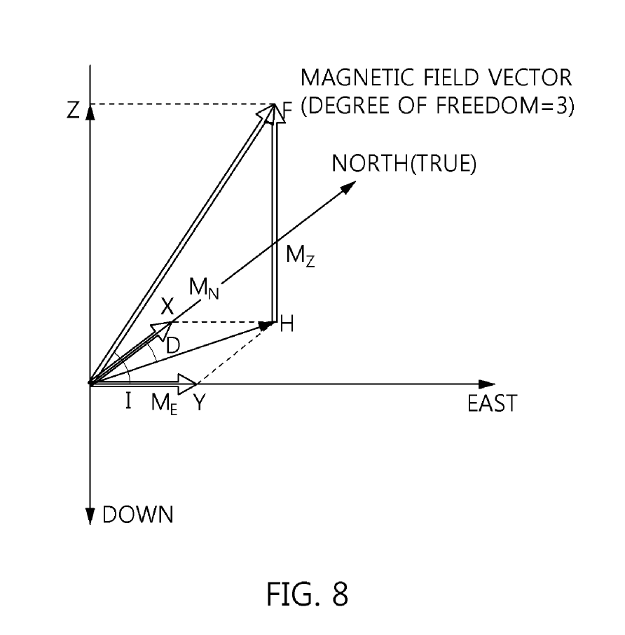

FIGS. 7 and 8 are diagrams illustrating a true north navigation coordinate system-based geomagnetic vector according to an embodiment of the present invention.

Referring to FIG. 7, a declination angle D may be an angle between true north and magnetic north on a horizontal plane.

An inclination angle I may be the angle between a geomagnetic field line and the horizontal plane.

Referring to FIG. 8, it can be seen that a true north geomagnetic field vector M_{N}, an eastward geomagnetic field vector M_{E}, and a vertical geomagnetic field vector M_{D}, which correspond to three degrees of freedom, are generated using the declination angle and the inclination angle.

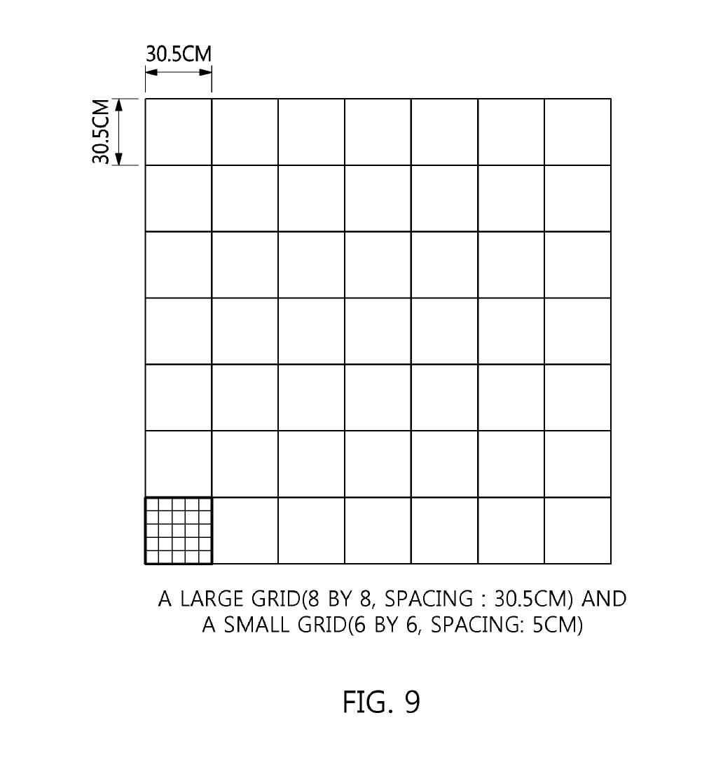

FIG. 9 is a diagram illustrating an indoor area in which grids are defined to generate geomagnetic field information according to an embodiment of the present invention.

Referring to FIG. 9, it can be seen that the indoor area is divided into large grid regions, which are first regions (in units of 30.5 cm), and that each first region is divided into small grid regions, which are second regions (in units of 5 cm).

Here, since a geomagnetic field generated from a ferromagnetic substance in the indoor area is not rapidly changed, a geomagnetic sensor may measure geomagnetic field values, which are changing in units of grid regions.

When a rapid change in a geomagnetic field appears between the units of grid regions, the indoor positioning system may compensate for measured geomagnetic field values depending on preset values.

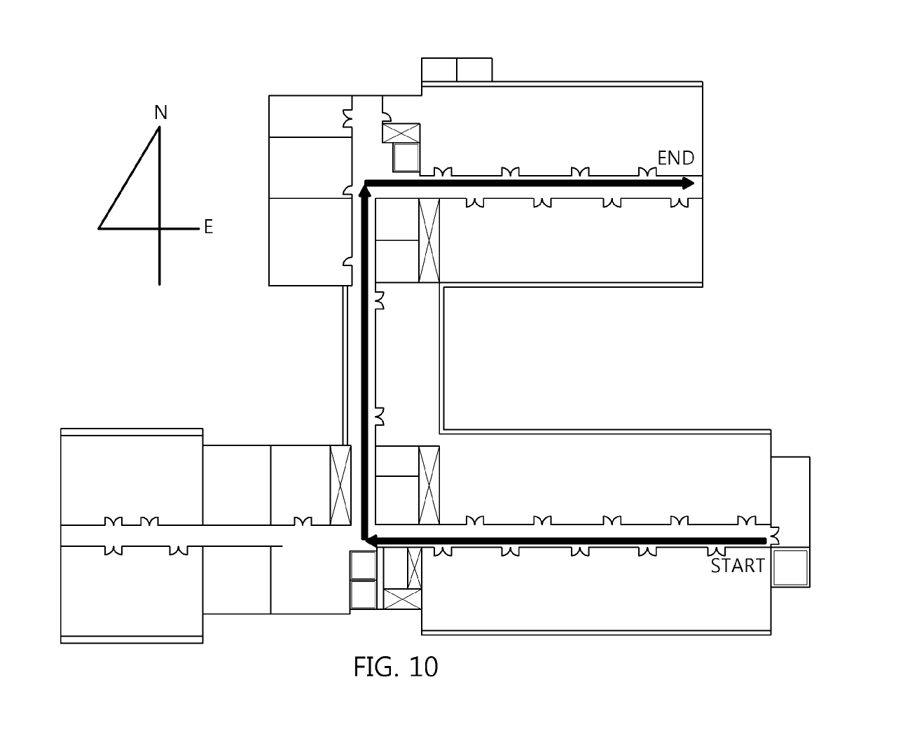

FIG. 10 is a diagram illustrating an indoor map on which indoor positioning is performed according to an embodiment of the present invention.

Referring to FIG. 10, it can be seen that a movement path through which a user moves from a start point START to an end point END while carrying the user terminal device 300 is marked on the indoor map.

The indoor positioning server device 200 may provide geomagnetic field heatmap information corresponding to the indoor map to the user terminal device 300.

Here, the user terminal device 300 may generate true north navigation coordinate system-based geomagnetic field information while correcting measurement information and a motion state depending on the movement of the user.

Here, the user terminal device 300 may compare the true north navigation coordinate system-based geomagnetic field information, which is generated during the movement to the end point, with the received geomagnetic field heatmap information, and may then perform indoor positioning using geomagnetic field information that exhibits a geomagnetic field pattern most similar to the generated true north navigation coordinate system-based geomagnetic field information.

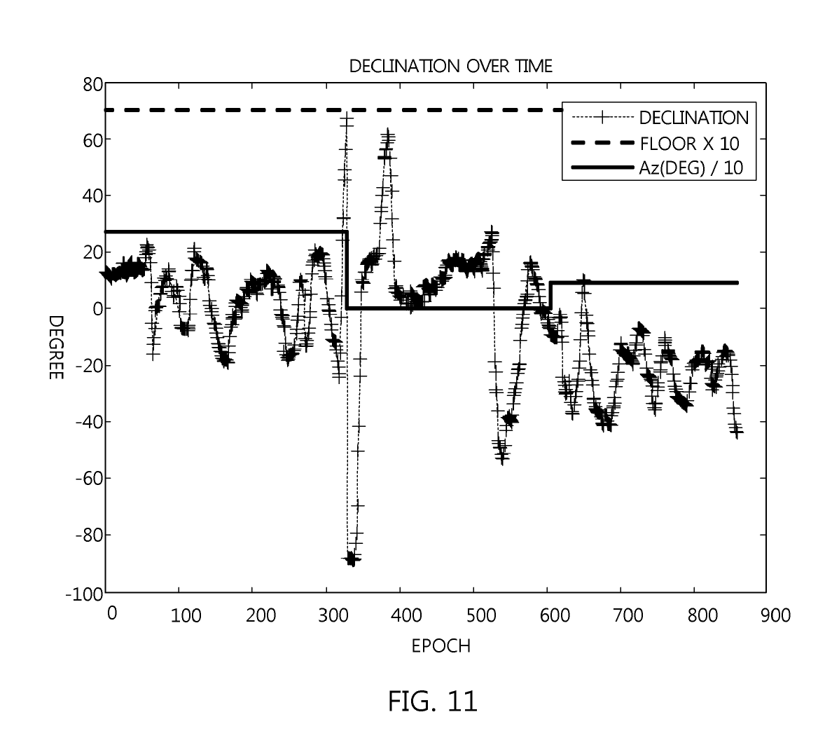

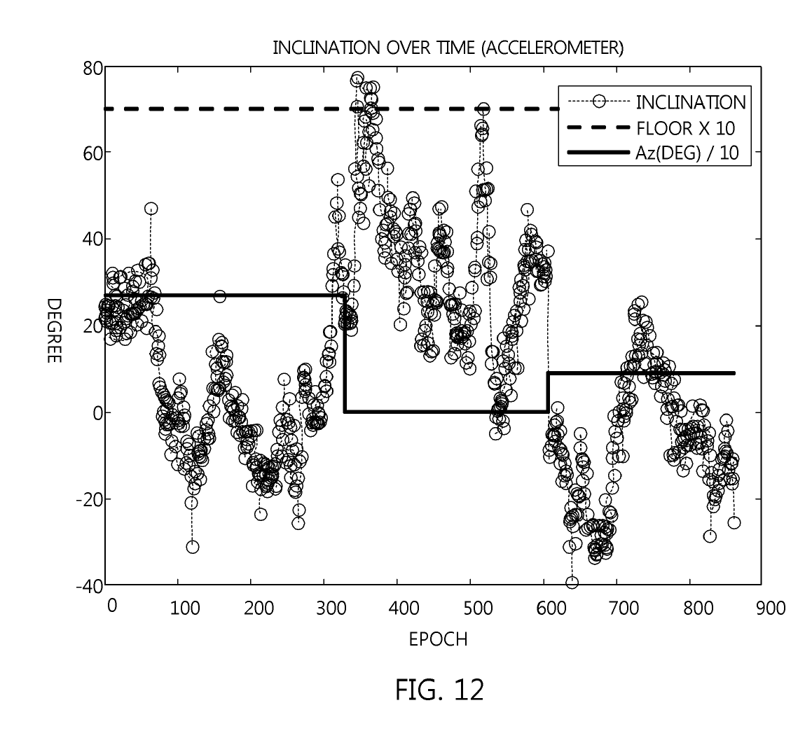

FIG. 11 is a graph illustrating declination angle information according to an embodiment of the present invention. FIG. 12 is a graph illustrating inclination angle information according to an embodiment of the present invention.

Referring to FIGS. 11 and 12, it can be seen that declination angle information and inclination angle information, which are generated while the user terminal device 300 is moving in the indoor map shown in FIG. 10, are depicted as a graph.

Here, the graph may represent a result obtained when the user terminal device 300 is moved along a “⊂”-shaped path while an azimuth changes from 270° to 0° and changes from 0° to 180°. Therefore, it can be seen that the values of the measured declination angle and inclination angle change with time.

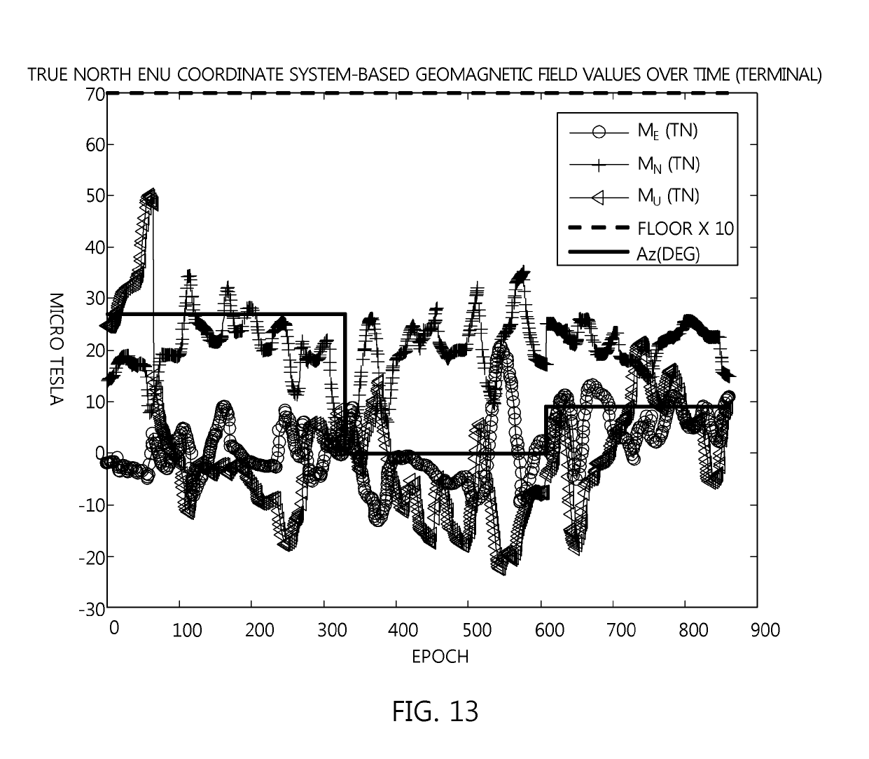

FIG. 13 is a graph illustrating geomagnetic field vector information before correction according to an embodiment of the present invention.

Referring to FIG. 13, it can be seen that true north navigation coordinate system-based geomagnetic field vector information generated by the user terminal device 300 is depicted as a graph.

Here, an upward geomagnetic field vector value may exhibit a discontinuous result while rapidly decreasing at a 100 epoch point. This may be due to faults in the sensors of the user terminal device 300, errors in application software, etc.

Therefore, when a change (difference) between geomagnetic field vector values is equal to or greater than a preset value, the indoor positioning system according to the embodiment of the present invention may compensate for the difference.

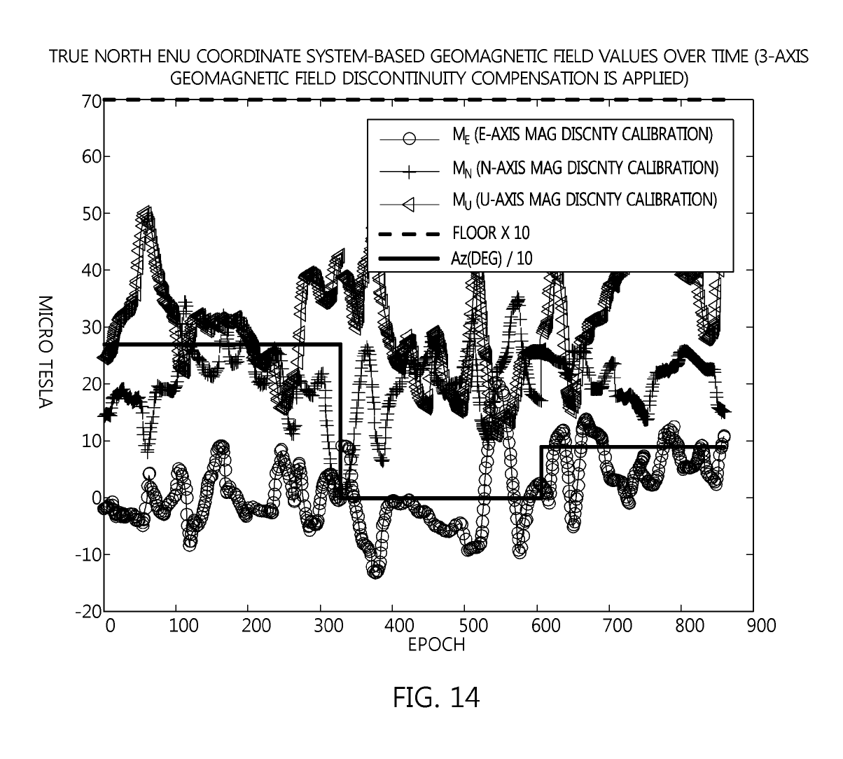

FIG. 14 is a graph illustrating geomagnetic field vector information after correction according to an embodiment of the present invention.

Referring to FIG. 14, it can be seen that continuous geomagnetic field vector values exhibit continuous values by compensating for discontinuous geomagnetic field vector values shown in FIG. 13.

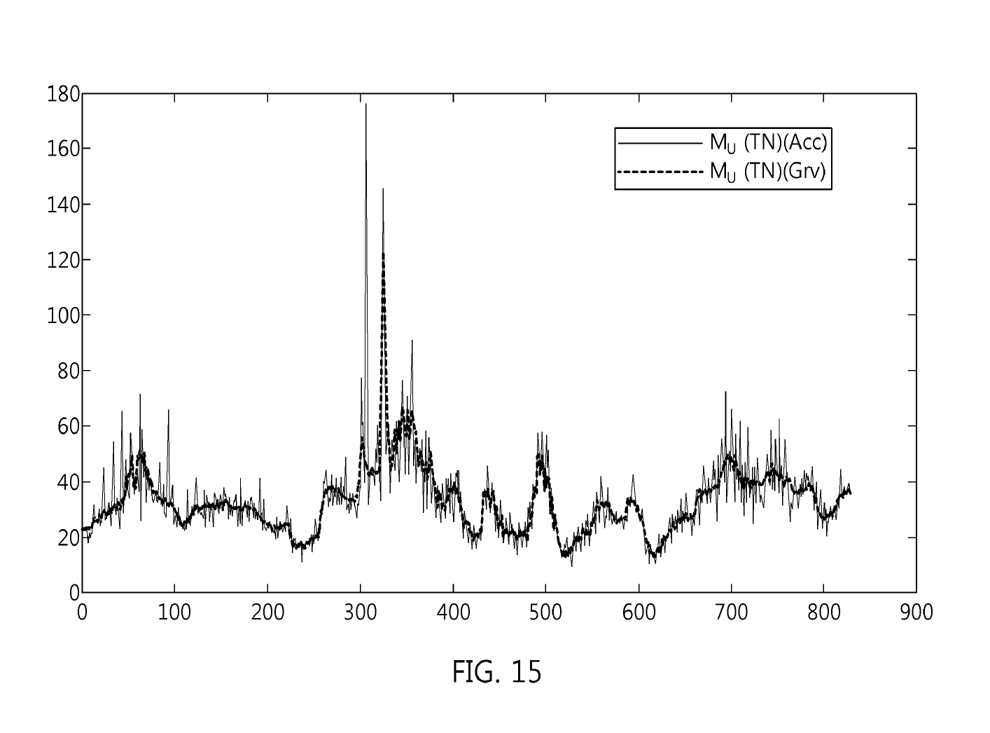

FIG. 15 is a graph illustrating upward geomagnetic field vector information before and after correction according to an embodiment of the present invention.

FIG. 15 illustrates the case where discontinuous upward geomagnetic field vector values are compensated for.

That is, it can be seen that, compared to the upward geomagnetic field vector values before compensation, which are indicated by a solid line in the graph, the upward geomagnetic field vector values after compensation, which are indicated by a dotted line, continuously appear.

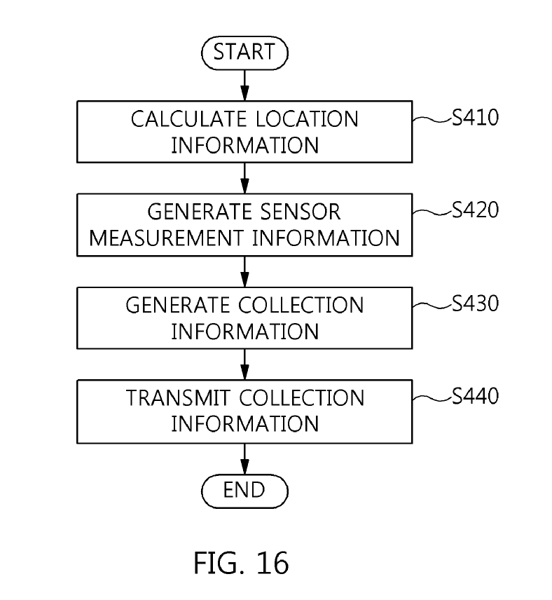

FIG. 16 is a flowchart illustrating a collection information generation method performed by the collection terminal device according to an embodiment of the present invention.

Referring to FIG. 16, the collection information generation method performed by the collection terminal device according to an embodiment of the present invention may first calculate location information at step S410.

That is, at step S410, the location formation may be generated by combining indoor node/link information at collection locations using sensors included in the collection terminal device 100.

Here, the sensors may include a geomagnetic sensor, an accelerometer, a gravimeter, a gyroscope, an altimeter, a camera, etc.

Further, the collection information generation method performed by the collection terminal device according to the embodiment of the present invention may generate sensor measurement information at step S420.

That is, at step S420, the measurement information may be generated by measuring the azimuths, acceleration vectors, gravity vectors, rotation vectors, geomagnetic field vectors, etc. at the collection locations using the sensors.

Here, the collection locations of the collection terminal device 100 may correspond either to pieces of location information (e.g. reference locations, absolute locations, relative locations, address locations, etc.) combined with the geomagnetic field heatmap information or to location indices (e.g. indices capable of referring to location information, rather than direct location information, in order to protect location information). The location information may be each collection location itself at which information is collected, or may correspond to virtual locations processed at regular intervals or reference locations.

Here, at step S420, the roll, pitch, and yaw angles of the collection terminal device 100 may be measured using the sensors.

Here, at step S420, the measurement information may be corrected by additionally considering measured atmospheric pressure information and temperature information.

Further, the collection information generation method performed by the collection terminal device according to the embodiment of the present invention may generate collection information at step S430.

That is, at step S430, the collection information may be generated using the location information and the measurement information, and may be stored while being temporally synchronized.

Further, the collection information generation method performed by the collection terminal device according to the embodiment of the present invention may transmit the collection information at step S440.

That is, at step S440, the collection information may be transmitted to the indoor positioning server device 200.

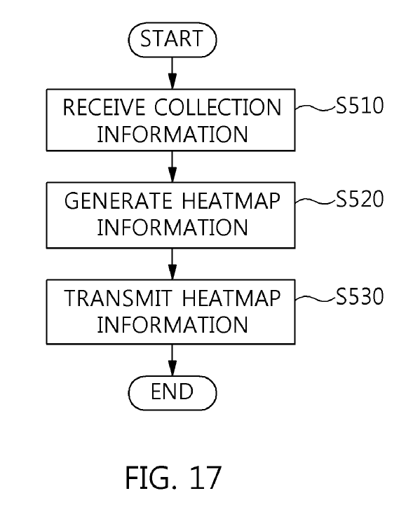

FIG. 17 is a flowchart illustrating a heatmap information generation method performed by the indoor positioning server device according to an embodiment of the present invention.

Referring to FIG. 17, the heatmap information generation method performed by the indoor positioning server device according to an embodiment of the present invention may receive collection information at step S510.

That is, at step S510, the collection information may be received from the collection terminal device 100.

Further, the heatmap information generation method performed by the indoor positioning server device according to the embodiment of the present invention may generate heatmap information at step S520.

That is, at step S520, geomagnetic field heatmap information may be generated using the collection information.

Here, at step S520, magnetic north or true north navigation coordinate system-based geomagnetic field vector information, declination angle information, and inclination angle information may be calculated using the collection information.

Here, at step S520, the magnetic north navigation coordinate system-based geomagnetic field vector information may be calculated using Equation (1).

Step S520 may be configured such that, as given by Equation (1), a terminal coordinate system-based geomagnetic field vector may be converted into the magnetic north navigation coordinate system-based geomagnetic field vector by multiplying the rotation vector matrices of the terminal by the terminal coordinate system-based geomagnetic field vector.

In this case, at step S520, terminal coordinate system-based geomagnetic field vectors for respective collection locations (reference locations) of an indoor map may be converted into magnetic north navigation coordinate system-based geomagnetic field vectors.

Further, at step S520, declination angle information may be generated using the collection information.

The declination angle may correspond to the angle between true north and magnetic north on a horizontal plane.

Here, at step S520, the declination angle may be calculated using Equation (5).

Here, an azimuth may correspond to an angle obtained by adding a magnetic bearing to a magnetic declination.

That is, at step S520, the declination angle may be calculated by subtracting the yaw angle from the azimuth of the collection terminal device 100, which is included in the collection information.

Further, at step S520, inclination angle information may be generated using the collection information.

The inclination angle may correspond to the angle at which a geomagnetic field line (magnetic needle) is inclined with respect to a horizontal direction.

Here, at step S520, the inclination angle may be calculated using Equation (6).

Here, at step S520, the magnetic north navigation coordinate system-based geomagnetic field vector information may be converted into true north navigation coordinate system-based geomagnetic field vector information, using the declination angle information and the inclination angle information.

Here, at step S520, a magnetic north navigation coordinate system-based geomagnetic field vector may be converted into a true north navigation coordinate system-based geomagnetic field vector using Equation (7).

Here, the magnetic north navigation coordinate system-based geomagnetic field vector may be converted into the true north navigation coordinate system-based geomagnetic field vector by multiplying a rotation inverse matrix, which is rotated at the declination angle along the z axis of the terminal coordinate system, by the magnetic north navigation coordinate system-based geomagnetic field vector.

Further, step S520 may be configured to generate a true north navigation coordinate system-based geomagnetic field vector using the inclination angle information and the declination angle information from a terminal coordinate system-based geomagnetic field vector, as given by Equation (8), without calculating the magnetic north navigation coordinate system-based geomagnetic field vector.

Here, step S520 may be configured to calculate a true north geomagnetic field vector M_{N}, an eastward geomagnetic field vector M_{E}, and a downward geomagnetic field vector M_{D}, using the magnitude of the terminal coordinate system-based geomagnetic field vector M_{xyz}, the declination angle D, and the inclination angle I, as represented by Equation (8).

Here, the downward geomagnetic field vector may be used as an upward geomagnetic field vector M_{U} by changing the negative (−) sign of the downward geomagnetic field vector to a positive (+) sign.

That is, any one of the up and downward geomagnetic field vectors may be used as a vertical geomagnetic field vector.

Here, at step S520, true north navigation coordinate system-based geomagnetic field vector information, which includes three elements or three degrees of freedom, may be generated.

Here, the true north navigation coordinate system-based geomagnetic field vector information may include three degrees of freedom, which correspond to a true north geomagnetic field vector, an eastward geomagnetic field vector, and a vertical (up or down) geomagnetic field vector, respectively.

Further, at step S520, geomagnetic field heatmap information may be generated by generating true north navigation coordinate system-based geomagnetic field vector information for respective collection locations using pieces of collection information received from multiple collection terminal devices 100.

Here, step S520 may be configured to generate, for each of indoor reference locations, geomagnetic field heatmap information using the true north navigation coordinate system-based geomagnetic field vector information, which includes three elements or three degrees of freedom.

Here, the geomagnetic field heatmap information may include, for each of the indoor reference locations, a true north geomagnetic field vector value, an eastward geomagnetic field vector value, and a vertical geomagnetic field vector value.

Here, the reference locations may correspond to the locations at which the collection terminal devices 100 are installed.

Here, the collection locations may correspond either to pieces of location information (e.g. reference locations, absolute locations, relative locations, address locations, etc.) combined with the geomagnetic field heatmap information, or location indices (e.g. indices capable of referring to location information, rather than direct location information, in order to protect location information). The location information may indicate collection locations themselves at which information is collected, may indicate virtual locations processed at regular intervals, or may indicate reference locations.

Here, the true north navigation coordinate system-based geomagnetic field vector may represent geomagnetic field information unique to each reference location regardless of the orientation or slope of the terminal.

Therefore, step S520 may be configured to generate accurate geomagnetic field heatmap information using the true north navigation coordinate system-based geomagnetic field vector, regardless of the slope, rotation or motion state of each collection terminal device 100.

Furthermore, at step S520, the geomagnetic field heatmap information may be compensated for.

Here, in the geomagnetic field heatmap information, discontinuity may occur over time due to the malfunctioning of the geomagnetic sensor of the collection terminal device 100 that collects measurement information, errors in application programs, etc.

In this case, since the geomagnetic field does not rapidly change in space, the geomagnetic field may have continuous geomagnetic field vector values at consecutive reference locations for each axis.

Therefore, when, for each axis, the difference between geomagnetic field vector values at consecutive reference locations is equal to or greater than a reference value, step S520 may be configured to compensate for the difference.

Here, when the difference between vector values at first and second consecutive reference locations with respect to at least one of a true north geomagnetic field vector, an eastward geomagnetic field vector, and a vertical (down or up) geomagnetic field vector, which correspond to three degrees of freedom included in the geomagnetic field heatmap information, is equal to or greater than a first preset value, step S520 may be configured to compensate for at least one vector corresponding to the second reference location so that the difference becomes less than the first preset value.

Further, the heatmap information generation method performed by the indoor positioning server device according to the embodiment of the present invention may transmit the heatmap information at step S530.

In detail, at step S530, the generated geomagnetic field heatmap information may be transmitted to the user terminal device 300.

Here, at step S530, information about locations at which collection terminal devices 100 are installed in indoor space, information about paths through which the user can move, branch point (node) information, azimuth information, etc. may be provided.

Here, at step S530, positioning capability information and positioning correction information may be transmitted to and received from the user terminal device 300.

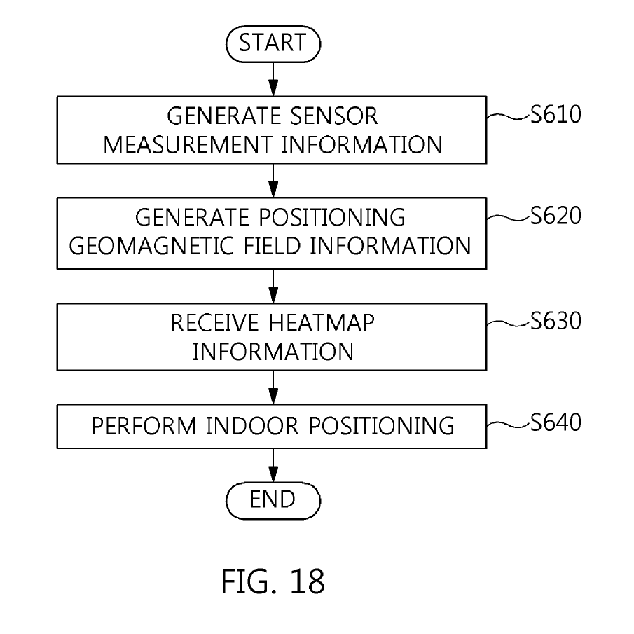

FIG. 18 is a flowchart illustrating an indoor positioning method performed by the user terminal device according to an embodiment of the present invention.

Referring to FIG. 18, the indoor positioning method performed by the user terminal device according to the embodiment of the present invention may generate sensor measurement information at step S610.

That is, at step S610, for the user terminal device 300, measurement information may be generated using a method similar to that of the collection sensor measurement unit 120 of the collection terminal device 100.

At step S610, measurement information related to a geomagnetic field at the current location and the slope of the user terminal device 300 itself may be generated by using sensors included in the user terminal device 300.

Here, the sensors may include a geomagnetic sensor, an accelerometer, a gravimeter, a gyroscope, an altimeter, a camera, etc.

Step S610 may be configured to generate measurement information by measuring an azimuth, an acceleration vector, a gravity vector, a rotation vector, a geomagnetic field vector, etc. for the slope of the user terminal device 300 using the sensors.

Here, at step S610, roll, pitch, and yaw angles of the user terminal device 300 are measured using the sensors, and thus at least one of the acceleration vector and the rotation vector may be calculated.

Here, at step S610, the measurement information may be corrected by additionally considering measured atmospheric pressure information and temperature information.

Further, the indoor positioning method performed by the user terminal device according to the embodiment of the present invention may generate positioning geomagnetic field information at step S620.

That is, step S620 may be configured to generate true north navigation coordinate system-based geomagnetic field information using a method similar to that of the heatmap information generation unit 220 of the indoor positioning server device 200.

Here, at step S620, magnetic north or true north navigation coordinate system-based geomagnetic field vector information, declination angle information, and inclination angle information may be calculated using the measurement information.

Here, at step S620, the magnetic north navigation coordinate system-based geomagnetic field vector information may be calculated using Equation (1).

In this case, step S620 may be configured to convert a terminal coordinate system-based geomagnetic field vector into a magnetic north navigation coordinate system-based geomagnetic field vector by multiplying the rotation vector matrices of the terminal by the terminal coordinate system-based geomagnetic field vector, as represented by Equation (1).

Here, at step S620, terminal coordinate system-based geomagnetic field vectors may be converted into magnetic north navigation coordinate system-based geomagnetic field vectors.

Further, step S620 may be configured to generate declination angle information using the measurement information.

The declination angle may correspond to the angle between true north and magnetic north on a horizontal plane.

Here, at step S620, the declination angle may be calculated using Equation (5).

That is, at step S620, the declination angle may be calculated by subtracting the yaw angle from the azimuth of the user terminal device 300, which is included in the measurement information.

Further, at step S620, the inclination angle information may be generated using the measurement information.

The inclination angle may correspond to the angle at which a geomagnetic field line (magnetic needle) is inclined with respect to a horizontal direction.

Here, at step S620, the inclination angle may be calculated using Equation (6).

Step S620 may be configured to convert the magnetic north navigation coordinate system-based geomagnetic field vector information into true north navigation coordinate system-based geomagnetic field vector information, using the declination angle information and the inclination angle information.

At step S620, a magnetic north navigation coordinate system-based geomagnetic field vector may be converted into a true north navigation coordinate system-based geomagnetic field vector using Equation (7).

Step S620 may be configured to convert the magnetic north navigation coordinate system-based geomagnetic field vector into the true north navigation coordinate system-based geomagnetic field vector by multiplying a rotation inverse matrix, which is rotated at the declination angle along the z axis of the terminal coordinate system, by the magnetic north navigation coordinate system-based geomagnetic field vector.

Further, step S620 may be configured to generate a true north navigation coordinate system-based geomagnetic field vector using the inclination angle information and the declination angle information from a terminal coordinate system-based geomagnetic field vector, as given by Equation (8), without calculating the magnetic north navigation coordinate system-based geomagnetic field vector.

Here, step S620 may be configured to calculate a true north geomagnetic field vector M_{N}, an eastward geomagnetic field vector M_{E}, and a downward geomagnetic field vector M_{D}, using the magnitude of the terminal coordinate system-based geomagnetic field vector M_{xyz}, the declination angle D, and the inclination angle I, as represented by Equation (8).

Here, the downward geomagnetic field vector may be used as an upward geomagnetic field vector M_{U} by changing the negative (−) sign of the downward geomagnetic field vector to a positive (+) sign.

That is, any one of the upward and downward geomagnetic field vectors may be used as a vertical geomagnetic field vector.

Here, at step S620, true north navigation coordinate system-based geomagnetic field vector information, which includes three elements or three degrees of freedom, may be generated.

In this case, the true north navigation coordinate system-based geomagnetic field vector information may include three degrees of freedom, which correspond to a true north geomagnetic field vector, an eastward geomagnetic field vector, and a vertical (up or down) geomagnetic field vector, respectively.

Further, at step S620, true north navigation coordinate system-based geomagnetic field vector information may be generated using the measurement information which is measured in the indoor movement path of the user terminal device 300.

Here, at step S620, true north navigation coordinate system-based geomagnetic field vector information, which includes three elements or three degrees of freedom in the indoor movement path, may be generated.

Here, the true north navigation coordinate system-based geomagnetic field vector information may include true north geomagnetic field vector values, eastward geomagnetic field vector values, and vertical geomagnetic field vector values in the indoor movement path.

The movement path may be a path along which the user terminal device 300 is moved in indoor space.

Here, the true north navigation coordinate system-based geomagnetic vector may represent geomagnetic field information unique to each reference location regardless of the orientation or slope of the terminal.

Therefore, step S620 may be configured to generate accurate geomagnetic field vector information using the true north navigation coordinate system-based geomagnetic field vector, regardless of the slope, rotation or motion state of the user terminal device 300.

Further, step S620 may be configured to compensate for the true north navigation coordinate system-based geomagnetic field vector information.

Here, in the true north navigation coordinate system-based geomagnetic field vector information, discontinuity may occur over time due to the malfunctioning of the geomagnetic sensor of the user terminal device 300 that generates the measurement information, errors in application programs, etc.

Here, since a geomagnetic field does not rapidly change in space, the geomagnetic field may have continuous geomagnetic field vector values at consecutive reference locations for each axis.

Therefore, step S620 may be configured to, when, for each axis, the difference between geomagnetic field vector values at consecutive reference locations in the movement path is equal to or greater than a reference value, compensate for the difference.

Here, when the difference between vector values at first and second consecutive reference locations in the movement path with respect to at least one of a true north geomagnetic field vector, an eastward geomagnetic field vector, and a vertical (down or up) geomagnetic field vector, which correspond to three degrees of freedom included in the true-north navigation coordinate system-based geomagnetic field vector information, is equal to or greater than a first preset value, step S620 may be configured to compensate for at least one vector corresponding to the second reference location so that the difference becomes less than the first preset value.

Further, the indoor positioning method performed by the user terminal device according to the embodiment of the present invention may receive heatmap information at step S630.

That is, at step S630, geomagnetic field heatmap information may be received from the indoor positioning server device 200.

Step S630 may be configured to receive information about locations at which collection terminal devices 100 are installed in indoor space, information about paths through which the user can be moved, branch point (node) information, azimuth information, etc.

Here, step S630, positioning capability information and positioning correction information may be transmitted to and received from the indoor positioning server device 200.

Furthermore, the indoor positioning method performed by the user terminal device according to the embodiment of the present invention may perform indoor positioning at step S640.

That is, step S640 may be configured to perform indoor positioning based on the true north navigation coordinate system-based geomagnetic field vector information and the geomagnetic field heatmap information.

Here, at step S640, the location of the user terminal device 300 may be estimated using the geomagnetic field heatmap information, received from the indoor positioning server device 200, and the true north navigation coordinate system-based geomagnetic field vector information.

In detail, step S640 may be configured to compare the true-north navigation coordinate system-based geomagnetic field vector information with pieces of geomagnetic field vector information for respective indoor reference locations included in the geomagnetic field heatmap information, and then estimate a reference location corresponding to the geomagnetic field vector information that is most similar to the true-north navigation coordinate system-based geomagnetic field vector information to be the location of the user terminal device 300.

Here, step S640 may be configured to individually compare the true north navigation coordinate system-based geomagnetic field vector information with a true north geomagnetic field vector, an eastward geomagnetic field vector, and a vertical geomagnetic field vector, which correspond to three degrees of freedom of the heatmap information, and then estimate the reference location of heatmap information at which the vectors corresponding to the three degrees of freedom are most similar to the true north navigation coordinate system-based geomagnetic field vector information to be the location of the user terminal device 300.

Here, at step S640, the true north navigation coordinate system-based geomagnetic field vector information may be corrected by filtering noise that occurs depending on the motion state based on the movement, speed, and rotational variation of the user terminal device 300.

Hereinafter, data fields used in the indoor positioning system according to an embodiment of the present invention will be described.

Sensors included in the collection terminal device 100 and the user terminal device 300 according to an embodiment of the present invention may use the data fields of sensor-provide assistance data (Sensor-Provide AssistanceData).

The data fields of Sensor-ProvideAssistanceData may be represented by the following Embodiment 1:

[Embodiment 1]

-- ASN1START
OMA-LPPe-Sensor-ProvideAssistanceData ::= SEQUENCE {

| ..., | |
|---|---|
| atmosphericPressureADOMA-LPPe-AtmosphericPressureAD | OPTIONAL, |

-- version 2.0 extension elements

| | |
|---|---|
| ver2-0-gmf-DataSet | SEQUENCE (SIZE (1..maxGMFDataSets)) OF OMA-LPPe-ver2-0- |

| | |
|---|---|
| GMF-DataSet | OPTIONAL, |

| | | |
|---|---|---|
| ver2-0-sensorError | OMA-LPPe-Sensor-Error | OPTIONAL, |

| | |
|---|---|
| ver2-0-server-tracking | NULL OPTIONAL |

}
maxGMFDataSets INTEGER ::= 8
-- ASN1STOP

Here, the data fields of Embodiment 1 may be described as shown in Table 1.

TABLE 1
OMA-LPPe-Sensor-ProvideAssistanceData field descriptions

atmosphericPressureAD
This field is used to provide reference atmospheric pressure at nominal
sea level, EGM96 to the target.
ver2-0-gmf-DataSet
This parameter provides data for up to 8 sets of geomagnetic fields, This
parameter is optional.
ver2-0-sensorError
This field is used to provide Sensor error causes related to the assistance
data requests.
ver2-0-server-tracking
This parameter indicates whether the server tracks Sensor assistance data
sent to a target. A target need not indicate to a server its possession of
any assistance data received previously for Sensors that is tracked when
sending an LPPe Request Assistance Data for Sensors. This parameter is
optional and encoded as a null value. Inclusion of the parameter indicates
the server tracks data for Sensors and omission indicates the server does
not.

Here, the data fields of atmospheric pressure assistance data (atmosphericPressureAD) in Embodiment 1 may be represented by the following Embodiment 2:

[Embodiment 2]

-- ASN1START
OMA-LPPe-AtmosphericPressureAD ::= SEQUENCE {

| | |
|---|---|
| referencePressure | INTEGER (−20000..10000), |

| | |
|---|---|
| period | SEQUENCE { |

| | |
|---|---|
| pressureValidityPeriod | OMA-LPPe-ValidityPeriod, |
| referencePressureRate | INTEGER (−128..127) OPTIONAL, |

| ... | |
|---|---|
| } | OPTIONAL, |

| | |
|---|---|
| area | SEQUENCE { |

| | |
|---|---|
| pressureValidityArea | OMA-LPPe-PressureValidityArea, |
| gN-pressure | INTEGER (−128..127) OPTIONAL, |
| gE-pressure | INTEGER (−128..127) OPTIONAL, |

| ... | |
|---|---|
| } | OPTIONAL, |

...

}
OMA-LPPe-PressureValidityArea ::= SEQUENCE {

| | |
|---|---|
| centerPoint | Ellipsoid-Point, -- coordinates of the center of the rectangular validity area |

| | |
|---|---|
| validityAreaWidth | INTEGER (1..128), -- units in Kilometers |
| validityAreaHeight | INTEGER (1..128), -- units in Kilometers |

...

}
-- ASN1STOP

Here, the data fields of Embodiment 2 may be described as shown in the following Table 2.

TABLE 2
OMA-LPPe-AtmosphericPressureAD field descriptions

referencePressure
This field specifies the atmospheric pressure (Pa) at nominal sea level, EGM96 to the target. If
pressureValidityArea is provided, the referencePressure applies to the center of the
pressureValidityArea. The pressure within the pressureValidityArea outside the center can be
calculated using the pressure gradients (gN-pressure and gE-pressure) if provided. If no
northward and eastward pressure gradients are provided, the pressure is assumed to be constant
throughout the pressureValidityArea. If no referencePressureRate is provided, the pressure is
assumed to be constant at each location throughout the pressureValidityPeriod. The scale
factor is 1 Pa. The value is added to the nominal pressure of 101325 Pa.
pressureValidityPeriod
This field specifies the start time and duration of the reference pressure validity period. If this
parameter is not present, the atmospheric pressure assistance data is valid only at precisely the
time the assistance data is received at the target.
referencePressureRate
This field specifies the rate of change of pressure. When this field is included, the
referencePresssure applies only at the start of the pressureValidityPeriod. The scale factor is 10
Pa/hour,
pressureValidityArea
This field specifies the area within which the provided atmospheric reference pressure is valid.
If this field is not present, the provided atmospheric reference pressure is only valid at the
target's position at the moment the atmospheric reference pressure is provided.
The pressure validity area is a rectangle defined by its Center Point (centerPoint), width
(validityAreaWidth) and height (validityAreaHeight). Width is measured from the center along
the latitude and height is measured from the center along the longitude. Width and height are
measured as the total width and height of the rectangle. The scale factor is Km.
gN-pressure
This field specifies the northward gradient of the reference pressure calculated from the center
of the pressureValidityArea. The scale factor is 10 Pa/Km. If this field is not provided, the
gradient is assumed to be zero.
gE-pressure
This field specifies the eastward gradient of the reference pressure calculated from the center of
the pressureValidityArea. The scale factor is 10 Pa/Km. If this field is not provided, the
gradient is assumed to be zero.

Further, the indoor positioning server device 200 according to an embodiment of the present invention may use the data fields of a geomagnetic field data set (GMF-DataSet).

Here, the data fields of the geomagnetic field data set (GMF-DataSet) may be represented by the following Embodiment 3:

[Embodiment 3]

-- ASN1START
OMA-LPPe-ver2-0-GMF-DataSet ::= SEQUENCE {

| | |
|---|---|
| ver2-0-gmf-heatmap | OMA-LPPe-ver2-0-GMF-HeatMap |

OPTIONAL
}
-- ASN1STOP

In this case, the data fields of Embodiment 3 may be described as shown in the following Table 3.

TABLE 3
OMA-LPPe-ver2-0-GMF-DataSet field descriptions

ver2-0-gmf-heatmap
This parameter applies only to LPPe 2.0 and provides GMF heatmap data
in the form of geomagnetic field strength and/or declination angle
and/or inclination angle data. This parameter is optional. A target
that receives new GMF heatmap data SHALL delete any previously
received GMF heatmap data.

Here, the data fields of a geomagnetic field heatmap (gmf-heatmap) in Embodiment 3 may be represented by the following Embodiment 4. The data fields of the geomagnetic field heatmap (gmf-heatmap) may used only in LPPe 2.0 and may provide geomagnetic field heatmap information indicated by true north, east, and vertical (upward or downward) components.

[Embodiment 4]

-- ASN1START
OMA-LPPe-ver2-0-GMF-HeatMap ::= SEQUENCE {

| heatMap-ID | OMA-LPPe-ver2-0-GMF-HeatMap-ID, | |
|---|---|---|
| validity-period | OMA-LPPe-ValidityPeriod | OPTIONAL, |

| | | |
|---|---|---|
| referenceGrid | OMA-LPPe-ver2-0-ReferenceGrid | OPTIONAL, |

| | |
|---|---|
| heatMap-Source | OMA-LPPe-ver2-0-HeatMap-Source |

| OPTIONAL, | | |
|---|---|---|
| x-offset | INTEGER (−32768..32767) | OPTIONAL, |
| y-offset | INTEGER (−32768..32767) | OPTIONAL, |

| | |
|---|---|
| x-length | INTEGER (1..4096), |
| y-length | INTEGER (1..4096), |

| | |
|---|---|
| compression | ENUMERATED {none (0), jpeg (1), ...}, |
| reorientation | SEQUENCE { |

| | |
|---|---|
| orientation-angle | INTEGER (−900..900), |

| shifting ENUMERATED {x-direction (0), y-direction (1)}, | |
|---|---|
| ... | |
| } | OPTIONAL, |

| | | |
|---|---|---|
| run-lengths | OMA-LPPe-RleList | OPTIONAL, |
| updateReqGridPoints | OMA-LPPe-RleList | OPTIONAL, |

| | |
|---|---|
| gmf-map | SEQUENCE { |

| | |
|---|---|
| gmf-N-mean-value | OCTET STRING, |
| gmf-E-mean-value | OCTET STRING, |
| gmf-D-mean-value | OCTET STRING, |

| gmf-N-standard-deviation OCTET STRING OPTIONAL, | |
|---|---|
| gmf-E-standard-deviation OCTET STRING OPTIONAL, | |
| gmf-D-standard-deviation OCTET STRING OPTIONAL, | |
| range | SEQUENCE { |

| | |
|---|---|
| gmf-minimum | INTEGER (−128..−10), |
| gmf-range | INTEGER (10..256) |
| } | OPTIONAL, |

| ... | |
|---|---|
| } | OPTIONAL, |

| | |
|---|---|
| declAngle-map | SEQUENCE { |

| | |
|---|---|
| declination-angle-mean-value | OCTET STRING, |

declination-angle-standard-deviation OCTET STRING

OPTIONAL,

Here, the data fields of Embodiment 4 may be described as shown in the following Table 4.

TABLE 4
OMA-LPPe-ver2-0-GMF-HeatMap field descriptions

heatmap-ID
This parameter provides a unique ID for the heatmap.
validity-period
This parameter defines the validity period for a heatmap and, if present, overrides any other
validity period provided by a server for any assistance data that may contain the heatmap. A
target that receives a heatmap should only make use of the heatmap during the validity period.
This parameter is optional.
referenceGrid
This parameter defines the origin, orientation and grid spacing for a reference grid relative to
which the heatmap is defined. This parameter is optional. If included, the provided reference
grid overrides any default reference grid provided by means of common group parameters (e.g.
for a WLAN AP or SRN AP). If absent, a reference grid is taken from common group
parameters (e.g. for a WLAN AP or SRN AP),
heatMap-Source
This parameter defines the source of the heatmap and may provide information associated with
the source. This parameter is optional. If absent, the source is undefined.
x-offset
This parameter provides the x coordinate offset relative to the reference frame origin for the
corner of the heatmap rectangular area that has minimum X and Y coordinates. This parameter
is encoded as an integer with range −32768 to 32767 which expresses a length in units of the
grid spacing. This parameter is optional. If not present, the x-offset is zero.
y-offset
This parameter provides the y coordinate offset relative to the reference frame origin for the
corner of the heatmap rectangular area that has minimum X and Y coordinates. This parameter
is encoded as an integer with range −32768 to 32767 which expresses a length in units of the
grid spacing. This parameter is optional. If not present, the y-offset is zero.
x-length
This parameter defines the length of the rectangular area for the heatmap in the X direction in
units of the grid spacing. This is encoded as an integer in the range 1 to 4096.
y-length
This parameter defines the length of the rectangular area for the heatmap in the Y direction in
units of the grid spacing. This is encoded as an integer in the range 1 to 4096.
Compression
This parameter defines the method used to compress the included heatmaps. Possible values
are none (meaning no compression) and JPEG (meaning JPEG compression).
Reorientation
This parameter enables a heatmap area to be reoriented at an angle θ (−90° ≦ θ ≦ 90°) to the
local Y axis. The reorientation is defined by the following fields:
orientation-angle gives the angle θ in units of one tenth of a degree
shifting defines whether rows of grid points are shifted in the positive X
direction or columns of grid points are shifted in the positive Y
direction
This parameter is optional and is only included when reorientation is used.
run-lengths
This parameter enables a heatmap area to fit an arbitrary shape by defining alternating run
lengths of excluded and included grid points. The parameter contains a sequence of integers I1,
I2, I3, I4 etc. with values between 0 and 255 where integers in odd positions (I1, I3, I5 etc.)
define a consecutive sequence of excluded grid points and integers in even positions (I2, I4
etc.) define a consecutive sequence of included grid points. The total number of all included
and excluded grid points SHALL be less than or equal to the total number of original grid
points. When the former is less than the latter, all remaining grid points (not so far included or
excluded) SHALL be assumed by a receiver to be excluded. This parameter is optional and
SHALL only be included when run lengths are used to create an arbitrary heatmap area.
updateReqGridPoints
This parameter provides a set of grid points for triggering a request for new transmitter
assistance data from a target if the target estimates its position near to one of these grid points,
This parameter is optional, but if this parameter is provided by the server, the server may send
this information only for one of the grouped transmitter heatmaps (and not for all of the heap
maps). The parameter contains a sequence of integers I1, I2, I3, I4 etc. with values between 0
and 255 where integers in odd positions (I1, I3, I5 etc.) define a consecutive sequence of grid
points that do not trigger updates and integers in even positions (I2, I4 etc.) define a
consecutive sequence of grid points that do trigger updates. The total number of all included
and excluded grid points SHALL be less than or equal to the total number of original grid
points. When the former is less than the latter, all remaining grid points (not so far included or
excluded) SHALL be assumed by a receiver to not trigger an update. The selection of update
grid points is out-of-scope of this specification.
gmf-map
This parameter provides a sequence of true northward, eastward and downward mean
geomagnetic field strength values and an optional sequence of true northward, eastward and
downward geomagnetic field strength standard deviations for successive included grid points
within the heatmap area. Each mean geomagnetic field strength values are encoded as integers
in the range 0 to 2550 as follows:
encoded value = 0: true (northward, eastward or downward) mean
geomagnetic field strength <= gmf-minimum
encoded value = 1-2549: true (northward, eastward or downward) mean
geomagnetic field strength = (gmf-minimum + (encoded value/2550)*gmf-range)
encoded value = 2550: true (northward, eastward or downward) mean
geomagnetic field strength >= (gmf-minimum + gmf-range)
where: gmf-minimum = minimum geomagnetic field strength in units of μ T (default is −128μ
T)
gmf-range = range of geomagnetic field strength in units of μ T (default is 255μ T)
Each geomagnetic field strength standard deviations are encoded as integers in the range 0 to
2550 as follows:
true (northward, eastward or downward) gmf strength standard deviation = (encoded
value/10) μ T
Successive geomagnetic field strength values appear according to a scan order of grid points.
When JPEG compression is used, this parameter contains an octet string that results from JPEG
compression of the original encoded geomagnetic field strength values. When JPEG
compression is used with run-lengths, dummy geomagnetic field strength values are included
for all grid points defined to be excluded by the run-lengths parameter.
declAngle-map
This parameter provides a sequence of mean declination angle values and an optional sequence
of declination angle standard deviations for successive included grid points within the heatmap
area. Declination angle is defined by the angle on the horizontal plane between magnetic north
and true north.
Mean declination angle values are encoded as integers in the range 0 to 3599 as follows:
encoded value = 0: mean declination angle <= da-minimum
encoded value = 1-3598: mean declination angle = (da-minimum + (encoded value/
3600)*da-range)
encoded value = 3599: mean declination angle >= (da-minimum + da-range)
where: da-minimum = minimum declination angle in units of degree (default is −180 degree)
da-range = range of declination angle in units of degree (default is 360 degree)
Declination angle standard deviations are encoded as integers in the range 0 to 3599 as follows:
Declination angle standard deviation = (encoded value/10) degree
Successive declination angle values appear according to a scan order of grid points. When
JPEG compression is used, this parameter contains an octet string that results from JPEG
compression of the original encoded declination angle values. When JPEG compression is used
with run-lengths, dummy declination angle values are included for all grid points defined to be
excluded by the run-lengths parameter.
inclAngle-map
This parameter provides a sequence of mean inclination angle values and an optional sequence
of inclination angle standard deviations for successive included grid points within the heatmap
area. Inclination angle is defined by the angle between the horizontal plane and the total
geomagnetic field vector, measured positive into Earth.
Mean inclination angle values are encoded as integers in the range 0 to 1799 as follows:
encoded value = 0: mean inclination angle <= ia-minimum
encoded value = 1-1798: mean inclination angle = (ia-minimum + (encoded value/
3600)*ia-range)
encoded value = 1799: mean inclination angle >= (ia-minimum + ia-range)
where: ia-minimum = minimum inclination angle in units of degree (default is −90 degree)
da-range = range of inclination angle in units of degree (default is 180 degree)
Inclination angle standard deviations are encoded as integers in the range 0 to 1799 as follows:
Inclination angle standard deviation = (encoded value/10) degree
Successive inclination angle values appear according to a scan order of grid points. When
JPEG compression is used, this parameter contains an octet string that results from JPEG
compression of the original encoded inclination angle values. When JPEG compression is used
with run-lengths, dummy inclination angle values are included for all grid points defined to be
excluded by the run-lengths parameter.

Here, the data fields of a heatmap identifier (HeatMap-ID) in Embodiment 4 may be represented by the following Embodiment 5:

[Embodiment 5]

-- ASN1START
OMA-LPPe-ver2-0-GMF-HeatMap-ID ::= SEQUENCE {

| | |
|---|---|
| vendorOrOperator | OMA-LPPe-VendorOrOperatorID, |
| heatmap-ID | OCTET STRING (SIZE (1..16)), |

...

}
-- ASN1STOP

TABLE 5
OMA-LPPe-ver2-0-GMF-HeatMap-ID field descriptions

vendorOrOperator
This parameter defines the vendor or operator who has assigned the
heatmap ID. This parameter is mandatory,
heatmap-ID
This parameter defines the heatmap ID for the particular vendor or
operator. The heatmap ID may contain a version or timestamp using
proprietary encoding. The heatmap-ID should change whenever a
heatmap is updated. The heatmap-ID is encoded as an octet string
of length 1 to 16 octets. This parameter is mandatory.

Further, the data fields of sensor-request assistance data (Sensor-RequestAssistanceData) may be represented by the following Embodiment 6. The data fields of the sensor-request assistance data (Sensor-RequestAssistanceData) may be used to request the support of a sensor-based method.

[Embodiment 6]

-- ASN1START
OMA-LPPe-Sensor-RequestAssistanceData ::= SEQUENCE {

| ..., | |
|---|---|
| pressureSensorAD | OMA-LPPe-PressureSensorAD OPTIONAL |

-- version 2.0 extension elements

| | | |
|---|---|---|
| ver2-0-geoMagneticFieldAD | BIT STRING {ver2-0-gmfHeatMap | (0), |

| | |
|---|---|
| ver2-0-declAngleHeatMap | (1), |
| ver2-0-inclAngleHeatMap | (2)} (SIZE(1..8)) |

OPTIONAL,

ver2-0-GMF-HeatMaps SEQUENCE (SIZE (1..ver2-0-maxGMFHeatMaps)) OF OMA-LPPe-

| | |
|---|---|
| ver2-0-GMF-HeatMap-ID | OPTIONAL, |

| | | |
|---|---|---|
| ver2-0-GMF-HeatMapUpdateReq | SEQUENCE | { |

| | |
|---|---|
| heatMap-ID | OMA-LPPe-ver2-0-GMF-HeatMap-ID, |
| updatingIndex | INTEGER (1..16777216), |
| targetHeading | OMA-LPPe-HighAccuracy3Dvelocity |

OPTIONAL,

...

| | |
|---|---|
| } | OPTIONAL |

}

| | |
|---|---|
| ver2-0-maxGMFHeatMaps | INTEGER ::= 4096 |

-- ASN1STOP

Here, the data fields of Embodiment 6 may be described as shown in the following Table 6.

TABLE 6
OMA-LPPe-Sensor-RequestAssistanceData field descriptions

ver2-0-geoMagneticFieldAD
This parameter specifies the geomagnetic field assistance data requested. This is represented by
a bit string, with a one-value at the bit position means the particular assistance data is
requested; a zero-value means not requested. The following assistance data types are included:
ver2-0-gmfHeatMap: include an geomagnetic field strength heatmap if available
and, optionally, group data containing a reference grid. This bit
only applies to LPPe 2.0.
ver2-0-declAngleHeapMap: include a declination angle heatmap if available and,
optionally, group data containing a reference grid. This bit only
applies to LPPe 2.0.
ver2-0-inclAngleHeapMap: include an inclination angle heatmap if available and,
optionally, group data containing a reference grid. This bit only
applies to LPPe 2.0.
ver2-0-GMF-HeatMaps
This parameter applies only to LPPe 2.0 and enables a target to indicate to a server the
identities of all GMF heap maps previously received from this server for geomagnetic field.
This may enable a server to avoid resending the same heatmaps. This parameter is optional. A
target need not include this parameter if a server included the ver2-0-server-tracking field in the
OMA-LPPe-Sensor-ProvideAssistanceData data type for all RF heatmaps provided by this
server for geomagnetic field. Otherwise, a target should include this parameter for any
previously received GMF heatmaps for geomagnetic field that were indicated as not tracked by
the server if the target is requesting additional GMF heatmaps from the server for geomagnetic
field.
ver2-0-AP-HeatMapUpdateReq
This parameter applies only to LPPe 2.0 and provides the ID of a heatmap and an index of a
reference grid point within the heatmap that has triggered an update request for new assistance
data when the target estimates its position at or near to this grid point. The heatmap and the
reference grid point would have been provided earlier to the target via the
updateReqGridPoints parameter in the OMA-LPPe-ver2-0-GMF-HeatMap IE. Optionally, the
target may also send its heading and velocity information. This parameter is optional.

Further, the data fields of the sensor-provided capabilities (OMA-LPPe-Sensor-ProvideCapabilities) according to an embodiment of the present invention may be used to provide functions related to a sensor-based method. Here, the data fields of the sensor-provided capabilities (OMA-LPPe-Sensor-ProvideCapabilities) may be represented by the following Embodiment 7:

[Embodiment 7]

-- ASN1START
OMA-LPPe-Sensor-ProvideCapabilities ::= SEQUENCE {

| | |
|---|---|
| motionStateSupport NULL | OPTIONAL, --Cond MotionStateSupport |

| | |
|---|---|
| secondarySupport | NULL OPTIONAL, --Cond SecondarySupport |

| ..., | | |
|---|---|---|
| atmosphericPressureADSupport | NULL | OPTIONAL, --Cond |

AtmosphericPressureADSupport

| | | |
|---|---|---|
| atmosphericPressureSupport | NULL | OPTIONAL, --Cond AtmosphericPressureSupport |

-- version 2.0 extension elements

| | | |
|---|---|---|
| ver2-0-geomagneticfieldADSupport | BIT STRING { ver2-0-gmfHeatMap | (0), |

| | |
|---|---|
| ver2-0-declAngleHeatMap | (1), |

| | |
|---|---|
| ver2-0-inclAngleHeatMap | (2)}(SIZE(1..8)) |

OPTIONAL

}
-- ASN1STOP

Here, the data fields of Embodiment 7 may be described as shown in the following Tables 7 and 8.

TABLE 7

| Conditional presence | Explanation |
|---|---|
| MotionStateSupport | The field is mandatory present if the |
| | target supports motion state |
| | measurements; otherwise it is not |
| | present. |
| SecondarySupport | The field is mandatory present if the |
| | target supports secondary motion state |
| | measurements; otherwise it is not |
| | present. |
| AtmosphericPressureADSupport | The field is mandatory present if the |
| | target supports atmospheric pressure |
| | assistance data; otherwise it is not |
| | present. |
| AtmosphericPressureSupport | The field is mandatory present if the |
| | target supports atmospheric pressure |
| | measurements; otherwise it is not |
| | present. |

TABLE 8
OMA-LPPe-Sensor-ProvideCapabilities field descriptions

ver2-0-geomagneticfieldADSupport
This field specifies the geomagnetic field assistance data supported by the
target device. This is represented by a bit string, with a one-value at the
bit position means the particular assistance data is supported; a zero-
value means not supported. A zero-value in all bit positions or absence of
this field means no assistance data is supported. The following bits are
assigned for the indicated assistance data.
ver2-0-gmfHeatMap: geomagnetic field heatmap
ver2-0-declAngleHeatMap: declination angle heatmap
ver2-0-inclAngleHeatMap: inclination angle heatmap

Furthermore, the data fields of sensor error causes (OMA-LPPe-Sensor-Error) according to an embodiment of the present invention may be used when the collection terminal device 100 or the user terminal device 300 provides the causes of sensor errors to the indoor positioning server device 200. Here, the data fields of the sensor error causes (OMA-LPPe-Sensor-Error) may be represented by the following Embodiment 8:

[Embodiment 8]

-- ASN1START
OMA-LPPe-Sensor-Error ::= CHOICE {

| | |
|---|---|
| targetError | OMA-LPPe-Sensor-TargetError, |

...,

-- version 2.0 extension elements

| | |
|---|---|
| ver2-0-LocationServerError | OMA-LPPe-Sensor-LocationServerError |

}
OMA-LPPe-Sensor-TargetError ::= SEQUENCE {

| | |
|---|---|
| motionStateError | ENUMERATED { primaryMotionStateNotAvailable, |

| primaryMotionStateNotSupported, | |
|---|---|
| ... } | OPTIONAL, |

| | |
|---|---|
| secondaryMotionStateError | ENUMERATED { secondaryMotionStateNotAvailable, |

| secondaryMotionStateNotSupported | |
|---|---|
| ... } | OPTIONAL, |

| ..., | |
|---|---|
| atmosphericPressureError | ENUMERATED {pressureNotAvailable, |

pressureNotSupported,

| | |
|---|---|
| ...} | OPTIONAL, |

-- version 2.0 extension elements

| | | |
|---|---|---|
| ver2-0-gmfNotAvailable | NULL | OPTIONAL, |

| | | |
|---|---|---|
| ver2-0-declAngleNotAvailable | NULL | OPTIONAL, |
| ver2-0-inclAngleNotAvailable | NULL | OPTIONAL |

}
OMA-LPPe-Sensor-LocationServerError ::= SEQUENCE {

| | | |
|---|---|---|
| ver2-0-gmfHeatMapsUnavailable | NULL | OPTIONAL, |
| ver2-0-declAngleHeatMapsUnavailable | NULL | OPTIONAL, |
| ver2-0-inclAngleHeatMapsUnavailable | NULL | OPTIONAL |

}
-- ASN1STOP

Here, the data fields of Embodiment 8 may be described as shown in the following Table 9.

TABLE 9
OMA-LPPe-Sensor-Error field descriptions

targetError
This field is used to provide target error information to the server.
motionStateError
This field is used to provide error information on the motion state
measurement to the server.
ver2-0-gmfUnavailable
This field applies to LPPe 2.0 only. When present it indicates that
a geomagnetic field in a target device is not available.
ver2-0-declAngleUnavailable
This field applies to LPPe 2.0 only. When present it indicates that
a declination angle in a target device is not available.
ver2-0-inclAngleUnavailable
This field applies to LPPe 2.0 only. When present it indicates that
an inclination angle in a target device is not available.
ver2-0-gmfHeatMapsUnavailable
This field applies to LPPe 2.0 only. When present it indicates that
a geomagnetic field Heatmap assistance data is not available.
ver2-0-declAngleHeatMapsUnavailable
This field applies to LPPe 2.0 only. When present it indicates that
a declination angle Heatmap assistance data is not available.
ver2-0-inclAngleHeatMapsUnavailable
This field applies to LPPe 2.0 only. When present it indicates that
an inclination angle Heatmap assistance data is not available.

The above-described data fields may be used in the collection terminal device 100, the indoor positioning server device 200, and the user terminal device 300 in the indoor positioning system.

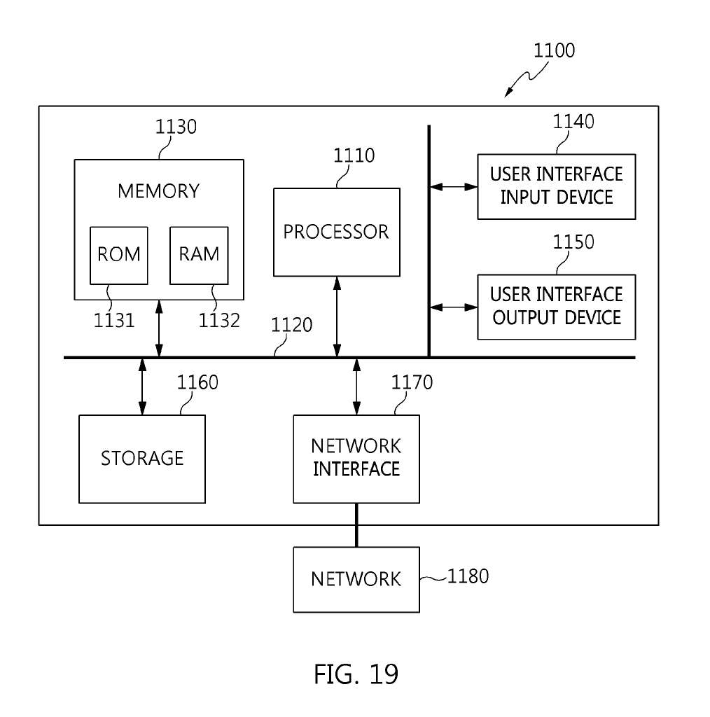

FIG. 19 is a block diagram illustrating a computer system according to an embodiment of the present invention.

Referring to FIG. 19, the embodiment of the present invention may be implemented in a computer system 1100, such as a computer-readable storage medium. As shown in FIG. 19, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each of the processors 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read Only Memory (ROM) 1131 or Random Access Memory (RAM) 1132.

The present invention may correct indoor positioning information by compensating for geomagnetic field distortion caused by a ferromagnetic substance that influences a geomagnetic field in an indoor environment.

Further, the present invention may improve the accuracy of indoor positioning by providing stable measurement information related to the movement of a terminal.

Furthermore, the present invention may store pieces of geomagnetic vector information for respective reference locations in indoor space into a database so as to compensate for geomagnetic field distortion.

As described above, in the indoor positioning system and method according to the present invention, the configurations and schemes in the above-described embodiments are not limitedly applied, and some or all of the above embodiments can be selectively combined and configured so that various modifications are possible.

What is claimed is:

1. An indoor positioning method performed by an indoor positioning system, comprising:
generating measurement information by measuring a geomagnetic field generated from a ferromagnetic substance present in indoor space and a slope of a user terminal device;
generating declination angle information and inclination angle information using the measurement information;
generating true north navigation coordinate system-based geomagnetic field vector information using the declination angle information and the inclination angle information;
receiving geomagnetic field heatmap information, generated using collection information that is collected at indoor reference locations; and
performing indoor positioning based on the true north navigation coordinate system-based geomagnetic field vector information and the geomagnetic field heatmap information.

2. The indoor positioning method of claim 1, wherein generating the measurement information is configured to generate the measurement information by measuring at least one of an azimuth, an acceleration vector, a gravity vector, a rotation vector, and a geomagnetic field vector of the user terminal device, which are based on a terminal coordinate system, using sensors included in the user terminal device.

3. The indoor positioning method of claim 2, wherein generating the declination angle information and the inclination angle information is configured to calculate an angle, obtained by subtracting a yaw angle from the azimuth, as the declination angle.

4. The indoor positioning method of claim 3, wherein generating the declination angle information and the inclination angle information is configured to calculate the inclination angle from the geomagnetic field vector and any one of the acceleration vector and the gravity vector, using an inner product operator and a norm operator.

5. The indoor positioning method of claim 4, wherein the true north navigation coordinate system-based geomagnetic field vector information includes three degrees of freedom, wherein the three degrees of freedom correspond to a true north geomagnetic field vector, an eastward geomagnetic field vector, and a vertical geomagnetic field vector, respectively.

6. The indoor positioning method of claim 5, wherein performing the indoor positioning is configured to estimate a location of the user terminal device using the geomagnetic field heatmap information, received from an indoor positioning server device, and the true north navigation coordinate system-based geomagnetic field vector information.

7. The indoor positioning method of claim 6, wherein performing the indoor positioning is configured to compare the true north navigation coordinate system-based geomagnetic field vector information with pieces of geomagnetic field vector information for respective indoor reference locations, included in the geomagnetic field heatmap information, and estimate a reference location corresponding to geomagnetic field vector information that is most similar to the true north navigation coordinate system-based geomagnetic field vector information to be the location of the user terminal device.

8. The indoor positioning method of claim 7, wherein performing the indoor positioning is configured to individually compare the compare the true north navigation coordinate system-based geomagnetic field vector information with the true north geomagnetic field vector, the eastward geomagnetic field vector, and the vertical geomagnetic field vector, which correspond to the three degrees of freedom of the geomagnetic field heatmap information, and estimate a reference location of the heatmap information at which the vectors corresponding to the three degrees of freedom are most similar to the true north navigation coordinate system-based geomagnetic field vector information to be the location of the user terminal device.

9. An indoor positioning system, comprising:
a user terminal device for generating declination angle information and inclination angle information using measurement information obtained by measuring a geomagnetic field present in indoor space and a slope of the user terminal device, generating true north navigation coordinate system-based geomagnetic field vector information using the declination angle information and the inclination angle information, and performing indoor positioning based on the true north navigation coordinate system-based geomagnetic field vector information and geomagnetic field heatmap information; and
an indoor positioning server device for generating the geomagnetic field heatmap information using collection information that is collected at indoor reference locations in order to perform indoor positioning, and providing the geomagnetic field heatmap information to the user terminal device.

10. The indoor positioning system of claim 9, wherein the true north navigation coordinate system-based geomagnetic field vector information includes three degrees of freedom, wherein the three degrees of freedom correspond to a true north geomagnetic field vector, an eastward geomagnetic field vector, and a vertical geomagnetic field vector, respectively.

11. The indoor positioning system of claim 10, wherein the indoor positioning server device generates the geomagnetic field heatmap information using true north navigation coordinate system-based geomagnetic field vector information, which is calculated from the collection information collected at the reference locations.

12. The indoor positioning system of claim 11, wherein the indoor positioning server device is configured such that, when a difference between pieces of geomagnetic field vector information at consecutive reference locations of the geomagnetic field heatmap information is equal to or greater than a first preset value, the difference between the pieces of geomagnetic field vector information is compensated for in order to make the difference be less than the first preset value.

13. The indoor positioning system of claim 12, wherein the indoor positioning server device is configured such that, when a difference between vector values at first and second consecutive reference locations with respect to at least one of a true north geomagnetic field vector, an eastward geomagnetic field vector, and a vertical geomagnetic field vector, which correspond to three degrees of freedom included in geomagnetic field heatmap information, is equal to or greater than the first preset value, the at least one vector is compensated for in order to make the difference be less than the first preset value.

14. The indoor positioning system of claim 13, wherein the user terminal device estimates a location of the user terminal device using the geomagnetic field heatmap information, received from the indoor positioning server device, and the true north navigation coordinate system-based geomagnetic field vector information.

15. The indoor positioning system of claim 14, wherein the user terminal device compares the true north navigation coordinate system-based geomagnetic field vector information with pieces of geomagnetic field vector information for respective indoor reference locations, included in the geomagnetic field heatmap information, and estimates a reference location corresponding to geomagnetic field vector information that is most similar to the true north navigation coordinate system-based geomagnetic field vector information to be the location of the user terminal device.

16. The indoor positioning system of claim 15, wherein the user terminal device individually compares the true north navigation coordinate system-based geomagnetic field vector information with the true north geomagnetic field vector, the eastward geomagnetic field vector, and the vertical geomagnetic field vector which correspond to the three degrees of freedom of the geomagnetic field heatmap information, and estimates a reference location of the geomagnetic heatmap information at which the vectors corresponding to the three degrees of freedom are most similar to the true north navigation coordinate system-based geomagnetic field vector information to be the location of the user terminal device.
